(19) United States
(12) Patent Application Publication
(10) Pub. No.: US 2011/0311710 A1
(43) Pub. Date: Dec. 22, 2011

(54) DETOXIFICATION OF JATROPHA CURCAS MEAL FOR FEEDING TO FARM ANIMAL SPECIES AND FISH

(75) Inventors: Harinder Makkar, Rome (IT); Klaus Becker, Nurtingen-Reudern (DE)

(73) Assignee: JATROSOLUTIONS GMBH, Stuttgart-Hohenheim (DE)

(21) Appl. No.: 13/201,118

(22) PCT Filed: Feb. 12, 2010
(86) PCT No.: PCT/EP2010/051779

§ 371 Date: Aug. 11, 2011

(30) Foreign Application Priority Data
Feb. 12, 2009 (EP) 09152699.6

(51) Int. Cl. A23L 1/015; A23K 1/18; A23K 1/16

(52) U.S. Cl. 426/655; 426/424; 426/431; 426/442

(57) ABSTRACT

The present invention relates to a method for detoxifying plant constituents from Jatropha, a detoxified material of Jatropha for producing a nourishment and uses thereof for producing a nourishment. Detoxification is performed with alkali (sodium hydroxyde) and short chain alcohol (methanol), resulting in removal of toxic phorbol esters.

### FIELD OF THE INVENTION

The present invention relates to the technical field of detoxification processes. Further, the present invention concerns methods for detoxifying plant constituents from toxic and low-toxic Jatropha, a detoxified material of Jatropha and the use of the detoxified material for producing nourishment.

### BACKGROUND OF THE INVENTION

Jatropha is a genus of succulent plants from the large family Euphorbiaceae with seeds that weigh from 0.4 to over 1 gram. One ton of Jatropha seeds yields approximately 650 kg of kernels that give an oil of about 390 kg. The residue of the extracted material, also called kernel meal, is about 260 kg. Jatropha oil is mainly used as a source of energy directly or after esterification. According to its fatty acid composition and physical parameters, it is well-suited for conversion into biodiesel by conventional processes, and quality parameters of biodiesel produced from Jatropha oil meet the EU's EN14214 standards.

Jatropha curcas, a certain species of the genus Jatropha, shows two different genotypes, a toxic and a low-toxic one. The toxic genotype is considered to be more resistant to diseases and is not grazed by animals. The toxicity of Jatropha curcas seed meal of the toxic genotype is ascribed to at least six different phorbol esters. The phorbol esters are reported to mimic the action of diacylglycerol, an activator of protein kinase C that regulates different signal transduction pathways. Interference with the activity of protein kinase C affects a number of processes including phospho lipid and protein synthesis, enzyme activities, DNA synthesis, phosphorylation of proteins, cell differentiation and gene expression. Phorbol esters are also co-carcinogens and have purgative and skin-irritant activities. In humans accidental poisoning by Jatropha curcas seeds has been reported to elicit giddiness, vomition and diarrhea. Mortality has also been reported in a number of animal species, like mice, chicks and goats.

Trypsin inhibitors, lectin and phytate are also present in Jatropha curcas seed meal of the toxic genotype at high concentrations. However, they were not responsible for acute toxicity. Trypsin inhibitors and lectins are heat-labile and can be destroyed by moist heating. In contrast, phorbol esters are heat-stable and hence heat treatment is not effective to detoxify kernel meal from the toxic genotype of Jatropha curcas.

The kernel meal of Jatropha curcas left after oil extraction is rich in protein with an acute protein content of approximately 60%. The levels of essential amino acids except lysine in kernel meal are comparable with the Food and Agriculture Organization (FAO) reference protein for a growing child of 2 to 5 years of age. A comparison between the amino acid composition of Jatropha curcas meal and soybeans revealed an almost similar pattern for all essential amino acids except lysine and sulfur amino acids, which are lower and higher, respectively, in the Jatropha curcas meal. Compared to castor bean meal, the levels of essential amino acids in the Jatropha meals are higher or similar to those of castor bean meal. This prompted the inventors to speculate that the kernel meal of Jatropha curcas would be an excellent feed after detoxification.

To detoxify Jatropha curcas press cake and oil, Gross et al. (1997) applied heat treatment with 91% moisture, followed by lyophilisation and washing with 92 ethanol. Subsequent feeding experiments with the detoxified press cake on fish and mice showed that fish grew and reproduced without problems, but mice grew slower than control groups fed on soy. The slower growth of mice is probably ascribed to the remaining 2% of toxic substances in the press cake. A toxicity evaluation by e.g. blood parameters or histopathology was not conducted. In addition, used fish were undefined ornamental aquarium fish.

In Aregheore et al. (2003), the kernel meal of the toxic Jatropha curcas genotype was detoxified by heat and different chemical treatments, wherein the defatted meal was mixed with either sodium hydroxide alone or sodium hydroxide with sodium hypochlorite to form a paste that was heat treated, lyophilisated and optionally washed with water or methanol. Controls groups were untreated, only treated by heat or heat treated followed by washing with methanol. The control and treated meals were used in diets to assess toxicity and nutritive value of detoxified Jatropha curcas meal in rats. In meals washed with methanol, phorbol ester concentrations were reduced up to 0.05 mg/g, and the growth was better than on casein containing diets. However, the rats on a casein containing diet showed diarrhea and adverse effects and therefore, this experiment cannot conclusively prove that the methanol washed meal was as good as casein diet. In addition, toxicity studies were not conducted. Therefore, it is not possible to conclude that these treatments provide a detoxified product safe for addition into feed for farm and aquaculture animals.

Martinez-Herrera et al. (2006) attempted different treatments on kernel meals samples of the toxic genotype of Jatropha curcas to neutralize the toxic antinutrients present. Trypsin inhibitors were easily inactivated with moist heating, the phytate level was slightly decreased by irradiation and the phorbol ester content was reduced either by ethanol extraction or sodium hydrogen carbonate treatment or a combination of both. The combination of ethanol and sodium hydrogen carbonate extraction achieved reduction of phorbol esters to 0.08 mg/g in the treated kernel meal. However, phorbol esters were still present in a detectable concentration that is too high for producing feed for farm animals and aquaculture species from the treated kernel meal.

Up to now, there is no method to remove phorbol esters from plant material to provide a safe feed for human or livestock diet, which nutritional value is still useful. Therefore, there is a great need for methods to detoxify plant material of toxic and low-toxic Jatropha species for producing a non-toxic substance still rich of protein.

The solution to this problem is achieved by the embodiments of the present invention characterized by the claims, and described further below.

### SUMMARY OF THE INVENTION

It is a first object of the present invention to provide a method for detoxifying plant constituents from Jatropha comprising the steps of:
a) providing a warm aqueous mixture of at least one plant constituent of Jatropha;
b) adding an alkali to the mixture to obtain a pH value of approximately 11;
c) separating the mixture to obtain a supernatant;
d) adding an acid to the supernatant at room temperature to obtain a pH value of approximately 8;
e) adding a short-chain alcohol to the supernatant to obtain a precipitate;
f) separating the precipitate from the supernatant, and
g) washing the precipitate with a short-chain alcohol,

wherein a phorbol ester concentration of the residue is below the detection limit of high performance liquid chromatography.

It is a further object of the present invention to provide a method for detoxifying plant constituents from Jatropha comprising in the following order the steps of:
a) providing at least one plant constituent of Jatropha;
b) adding a solvent comprising simultaneously methanol and sodium hydroxide to the constituent to obtain a mixture;
c) heating the mixture; and
d) separating the mixture to yield a residue;

wherein a phorbol ester concentration of the residue is below the detection limit of high performance liquid chromatography.

Several members of the genus Jatropha contain toxic amounts of phorbol esters and are thus not suited for direct animal feeding. However, plant constituents of toxic and low-toxic genotypes of Jatropha are the preferred starting material for the methods for detoxifying plant constituents from Jatropha as described herein.

Furthermore, the invention concerns a detoxified material of Jatropha obtainable by the methods according to the invention for producing a nourishment, wherein Jatropha is a toxic or low-toxic genotype of Jatropha and the concentration of phorbol esters in the detoxified material is 3 ppm or less.

In addition, the present invention is directed to the use of the detoxified material according to the invention for producing a nourishment, preferably a feed for farm animals and aquaculture species.

### BRIEF DESCRIPTION OF THE DRAWINGS

FIG. 1 shows an HPLC chromatogram of untreated Jatropha kernel meal, wherein the retention time is depicted on the X-axis and the intensity is depicted on the Y-axis. Detected phorbol ester peaks were emphasized by a circumferential rectangle.

FIG. 2 shows an HPLC chromatogram of a detoxified Jatropha kernel meal treated by step A for 30 minutes (as described in Materials and Methods).

FIG. 3 shows an HPLC chromatogram of a detoxified Jatropha kernel meal treated by steps A and B for a total of 60 minutes (as described in Materials and Methods).

FIG. 4 shows a weekly gain of common carps (Cyprinus carpio) that were fed by a diet containing different contents of detoxified Jatropha kernel meal treated by step A alone or steps A and B as well as control animals.

### DETAILED DESCRIPTION OF THE INVENTION

The present invention is directed to a method for detoxifying plant constituents from Jatropha comprising the steps of:
a) providing a warm aqueous mixture of at least one plant constituent of Jatropha;
b) adding an alkali to the mixture to obtain a pH value of approximately 11;
c) separating the mixture to obtain a supernatant;
d) adding an acid to the supernatant at room temperature to obtain a pH value of approximately 8;
e) adding a short-chain alcohol to the supernatant to obtain a precipitate;
f) separating the precipitate from the supernatant, and
g) washing the precipitate with a short-chain alcohol,

wherein a phorbol ester concentration of the residue is below the detection limit of high performance liquid chromatography.

The term “detoxifying” as used herein refers to reducing, removing or extracting at least one toxic agent from toxic and low-toxic plant constituents, so that they are non-toxic, i.e. elicits no signs of poisoning. Commonly, toxic plant constituents of Jatropha, e.g. kernel meal contain phorbol esters at a concentration of 2.2-2.7 mg/g kernel meal, whereas low-toxic plant constituents comprise phorbol esters at a concentration of 0.11-0.20 mg/g kernel meal. Therefore, detoxified material means material which stems from toxic or low toxic plant constituents and of which toxic phorbol esters are reduced, removed or extracted. The term “Jatropha” as used herein refers to a genus of approximately 175 succulent plants from the family Euphorbiaceae. As with many members of the family Euphorbiaceae, Jatropha contains compounds, which are highly toxic. Advantageously, Jatropha is resistant to drought, and produces seeds containing up to 40% oil. When the seeds are crushed and processed, the resulting oil can be used in a standard diesel engine as biodiesel, while the residue can also be processed into bio mass to power electricity plants or to be used as a fertilizer. The term “plant constituent” as used herein refers to any part of Jatropha including extracts, defatted kernel meal, processing residues, granulates, grounded particles of any size, leaves, seeds, fruits, sap, branches, ligneous parts, roots and shoots. The term “plant constituents” also comprise elements derived from Jatropha, e.g. elements that are modified or processed, like chemical derivates. The term “solvent comprising methanol and sodium hydroxide” as used herein refers to a liquid including methanol and sodium hydroxide. Added to the constituents from Jatropha, the solvent results in a liquid mixture that includes a homogeneous mixture, but particularly a heterogeneous mixture, such as a suspension and emulsion. The term “adding to obtain a mixture” as used herein includes all kinds of mixing and disintegration processes, like milling, grinding, crushing, shaking, vortexing, panning, rotating, or blending etc. The term “mixture” as used herein includes blends, composites and conglomerates. The term “separating the mixture” as used herein refers to isolating components from the mixture for example by precipitating, filtering, centrifuging, extracting, decanting, distillation, discarding the supernatant, obtaining a residue, capturing, or entrapping the desired substances. The term “phorbol ester” as used herein refers to any ester of phorbol, in which two hydroxyl groups on neighboring carbon atoms are esterified to fatty acids. Phorbol and phorbol esters are members of the tigliane family of diterpenes that are defined by polycyclic compounds. One of the most common phorbol esters is 12-O-tetradecanoylphorbol-13-acetate (TPA). Phorbol esters are generally known for their tumor promoting activity. The phorbol esters mimic the action of diacylglycerol, an activator of protein kinase C, which regulates different signal transduction pathways and several other metabolic activities. Even at very low concentrations phorbol esters contained in animal feed show toxicological manifestation. This toxicity limits the use of Jatropha constituents as feed for farm animals and aquaculture species. The term “detection limit of high performance liquid chromatography” as used herein refers to a concentration of a substance that is barely detectable by high performance liquid chromatography (HPLC). Below the HPLC detection limit the substance cannot be detected by HPLC any more. HPLC is a form of column chromatography to separate, identify and quantify compounds, wherein a column is utilized that holds for example chromatographic packing material, a pump that moves a mobile phase through the column and a detector that shows the retention times of the molecules. The detection limit of the HPLC method depends on the experimental conditions and amounts for instance to about 10 ppm. By optimizing the HPLC system in the present invention the detection limit is as low as approximately 3 ppm. The term “alkali” as used herein refers to a hydroxide of an alkali metal as e.g. Li, Na, and K, or an aqueous solution thereof. The term “acid” as used herein refers to a hydrogen ion donor, preferably selected from the group consisting of HCl, H₂SO₄ and H₂PO₄. The term short-chain alcohol as used herein refers to primary and secondary alcohols with maximally 10 carbons.

Jatropha kernel meal is a valuable by-product of oil and biodiesel production showing high crude protein content and a high quality in the composition of essential amino acids. By the detoxification methods according to the invention by-product and constituents of Jatropha can be used as nourishment, especially in feed for farm animals and aquaculture species. Thereby, Jatropha is used in different ways, and valuable area under crop that is otherwise needed for feed production can be saved. Particularly, in hot dry regions the nutrient conditions and agricultural situation can be improved by the method according to the invention, because Jatropha is resistant to drought and pest, and can be used to reclaim and cultivate poor and degraded soil. Scarcity of livestock feed is expected to be overcome to some extent by using the detoxified Jatropha kernel meal according to the invention.

A method is provided to detoxify plant constituents from Jatropha, based on the finding that phorbol esters can be removed from an aqueous mixture of plant constituents of Jatropha, if basification is used during liquid extraction and if a short-chain alcohol is only afterwards added to obtain protein enriched precipitate. Surprisingly, the removal of phorbol esters was particularly improved if the pH of the supernatant was reduced to pH 8 before applying the alcohol. Additional washing of the precipitate with short-chain alcohol further reduced the concentration of phorbol esters. By this it was possible to generate material originally derived from toxic or low-toxic Jatropha, in which no phorbol esters were detected using an optimized HPLC with a detection limit of 3 ppm.

This method allows removing phorbol esters and extracting protein from plant constituent simultaneously, thus providing detoxified and protein enriched material. Without being bound to any theory, it is believed that the treatment of plant constituents of Jatropha by steps a) to f) provides a solution of extracted protein and already reduced phorbol ester concentration, which is further detoxified by step g), resulting in detoxified and protein enriched material. Moreover, the protein content of the final product is particularly high, and thus further protein extraction methods are dispensable. The obtained product showed an amino acid composition comparable to commonly used protein sources as e.g. soy bean meal (Table 17) and may replace up to 75% of fishmeal protein in diets of common carp without impairing growth performance or nutrient utilization (Table 20, 21). Thus, the method efficiently provides a ready-to-use product that can be used for livestock feeding.

With this method it is possible to recover 19.7% phorbol ester free protein isolate from a Jatropha seed cake, compared to 14%-17% obtained by common methods e.g. using principles of isoelectric pH.

Feedings to common carp showed that diets containing the detoxified Jatropha protein isolate obtained by the described method are free of any compound that could be detrimental to animals, provide optimum digestible energy and a balanced amino acid profile for optimum growth. Indeed the obtained data indicate that common carp utilized detoxified Jatropha protein isolate even better than fish meal, retaining a maximal amount of nutrients in the body. Thus, the product obtained by the method according to the invention can be safely included in human nutrition and animal feed.

In a preferred embodiment of the invention, the short-chain alcohol added in step e) is added in a ratio of short-chain alcohol:supernatant of 3:1 to 5:1, preferably approximately 4:1. While optimizing the method, aliquots of the supernatant were mixed with different amounts of short-chain alcohol, wherein phorbol ester removal and protein extraction was most efficient when adding 4 times the amount of short-chain alcohol to the supernatant.

In a preferred embodiment, the short-chain alcohol added in step e) is about 70 vol.-% to 99 vol.-%, preferably about 80 vol.-% to 95 vol.-%, most preferred approximately 95 vol.-%. Optimizing studies showed that rising concentrations of short-chain alcohol are beneficial to the efficiency of protein extraction and phorbol ester removal. Therefore, 95 vol.-% short-chain alcohol is advantageously used for detoxification.

In a preferred embodiment, the short-chain alcohol added in step g) is about 70 vol.-% to 85 vol.-%, most preferred approximately 80 vol.-%. Surprisingly and in contrast to step e), the subsequent washing is optimized by reducing the vol.-% of the short-chain alcohol. When washing the residue with approximately 80 vol.-% of the short-chain alcohol, phorbol esters are most efficiently removed, such that no phorbol esters can be detected in the product by HPLC.

In a preferred embodiment, the short-chain alcohol is ethanol or methanol, preferably ethanol. It has been found that if the alcohol is not added until the supernatant is re-acidifying to pH 8 (step d), the removal of phorbol esters is particularly improved by using ethanol. Similarly, washing the precipitate is most efficient using ethanol. Therefore, without being bound to any theory, it is believed that steps a) to f) of the method dissolve and partly destroy phorbol esters from the plant constituent, and the remaining phorbol esters are then efficiently removed by washing the precipitate with ethanol. This removal was most efficient using 80 vol.-% ethanol.

In addition, the preferred embodiments of the method described below may also apply to the first aspect of the present invention.

In a second aspect, the present invention is directed to a method for detoxifying plant constituents from Jatropha comprising in the following order the steps of:
a) providing at least one plant constituent of Jatropha;
b) adding a solvent comprising simultaneously methanol and sodium hydroxide to the constituent to obtain a mixture;
c) heating the mixture; and
d) separating the mixture to yield a residue;

wherein a phorbol ester concentration of the residue is below the detection limit of high performance liquid chromatography.

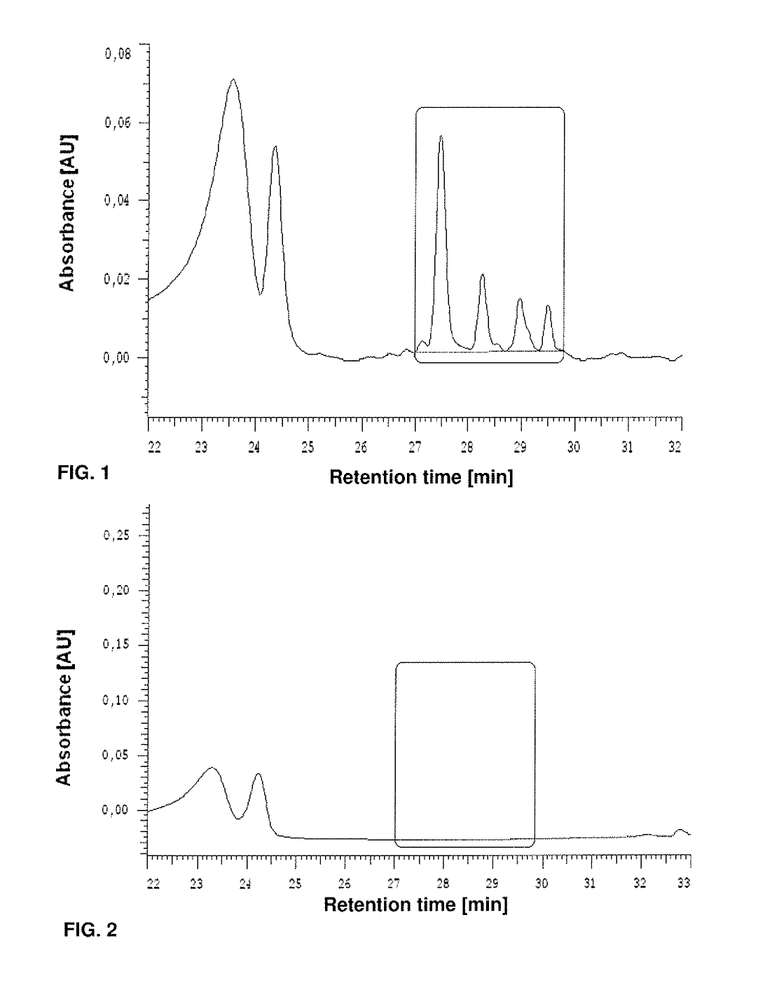

According to the invention, a process is provided to detoxify plant constituents from Jatropha, based on the removal of phorbol esters using methanol in presence of alkali followed by heating and separating the mixture to yield a residue. The phorbol ester concentration of the residue is below the detection limit of HPLC. An HPLC chromatogram of untreated Jatropha plant constituents shows four peaks of elution that represent phorbol esters (FIG. 1). These phorbol ester peaks are absent in HPLC chromatograms of Jatropha constituents treated according to the invention (FIG. 2), which means that plant material detoxified according to the invention is free of phorbol esters as determined by HPLC.

Without intending to be bound by any theory, it is believed that reduction in phorbol ester concentration of the residue below the detection limit of HPLC is ascribed to (i) the order of the method steps a) to d) and (ii) the combined application of methanol and sodium hydroxide to Jatropha plant constituents. Using methanol alone without sodium hydroxide (NaOH) produces a residue containing a remarkable content of phorbol esters of 0.06 mg/g showing that NaOH during extraction is imperative to reduce the phorbol ester concentration of the residue below the detection limit of HPLC. When Jatropha constituents were heat treated or autoclaved before the treatment with methanol alone or methanol in combination with NaOH the phorbol ester content of the product was 0.05 mg/g, whereas phorbol esters were not detected by HPLC in residues detoxified by the method according to the invention. This indicates that the order of solvent extraction and heat treatment is decisive.

In a preferred embodiment of the invention the method further comprises in the following order the steps of:
e) adding methanol to the residue to obtain a blend;
f) heating the blend; and
g) separating the blend to obtain a second residue.

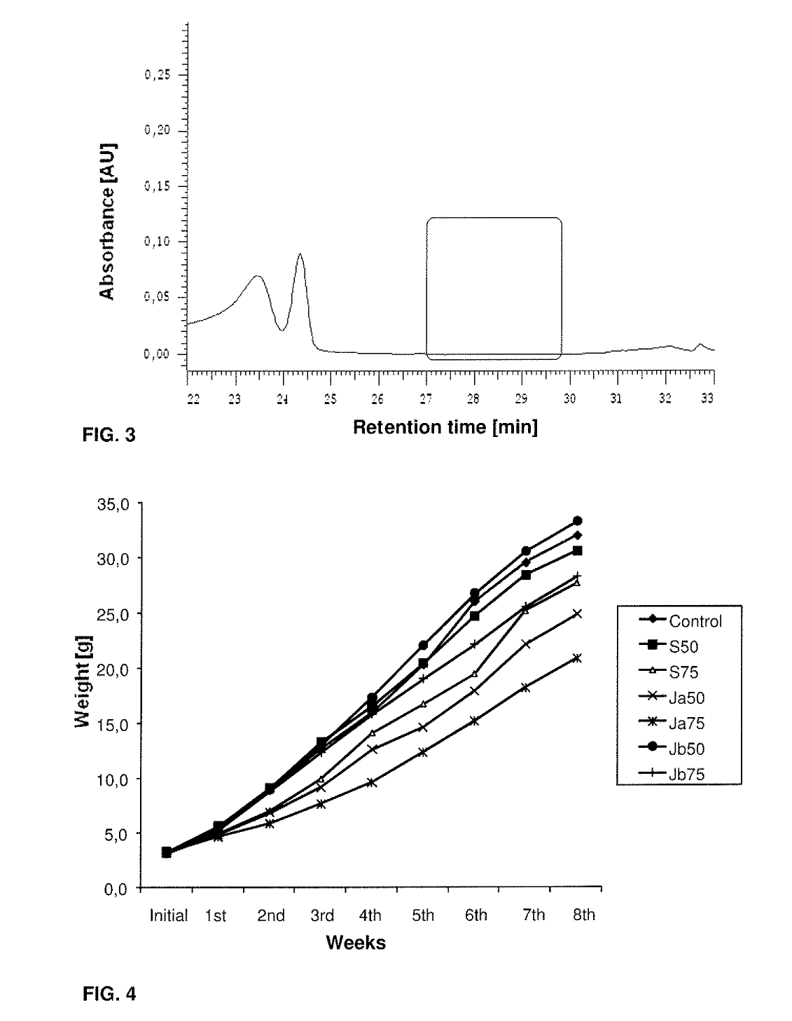

Steps e) to g) further reduce the phorbol ester concentration of the second residue compared to the first residue. An HPLC chromatogram of untreated Jatropha plant constituents shows four peaks of elution that represent phorbol esters (FIG. 1). These phorbol ester peaks are absent in HPLC chromatograms of the second Jatropha residue detoxified according to the invention (FIG. 3), which means that the phorbol ester concentration of second residue is at least below the detection limit of HPLC.

In addition, the detoxification process leading to the second residue does not decrease the amino acid content and decreases the protein availability only slightly, as measured by pepsin and pepsin plus trypsin digestibility. However, the protein digestibility of the detoxified second residue is still of the same order as for soy meal, ground nut meal and other conventional seed meals.

The second residue according to the invention showed total protein and amino acid contents that are similar to that in untreated raw material from Jatropha. The performance of the feed, whose content of fish meal protein is replaced at 75 by the detoxified second residue according to the invention, was comparable to the feed, whose content of fish meal protein is replaced at 75% by soybean meal, but was lower compared to unreplaced 100% fish meal feed. Furthermore, the performance of the feed, whose content of fish meal protein is replaced at 50% by the detoxified second residue according to the invention, was similar to unreplaced 100% fish meal feed. Therefore, the second residue according to the invention can be safely included in human nutrition and animal feed.

In another embodiment the phorbol ester content of the second residue according to the invention is tested in living animals that are more sensitive to toxic substances than HPLC. In a bioassay of a mollusk the method for detoxification according to the invention reduces phorbol ester concentration of the second residue so that 100% of mollusks treated with the second residue survive, i.e. no mortality is induced. This means that the second residue exerts no effect on survival rate.

The term “mollusk” as used herein refers to an animal belonging to the phylum mollusca that is divided into 10 classes, like Gastropoda, Cephalopoda and Bivalvia. Mollusks have developed a manifold range of body structures with few syn-apomorphies, like two pairs of main nerve cords, the dorsal mantle, which secrets calcareous spicules, plates or shells, and the anus and genitals that open into the mantle cavity. The term “bioassay” as used herein refers to a system, wherein the effect of potential toxic substances on living organisms was tested. The bioassay can be qualitative or quantitative, and the organism under investigation can be in an artificial or natural environment. In the most preferred embodiment mollusk activity is measured in an aqueous solution of the substance under investigation at appropriate concentrations and exposure times. After the exposure time the substance is washed away from the organisms, placed in control solution and left under observation for further time, after which the organisms are collected and counted. Mortality is indicated for example by discoloration, absence of muscle contraction, hemorrhage and deterioration of the body tissues.

Phorbol esters are known to affect mollusks and cause 100% mortality at 1 ppm (0.001 mg/g) in water. The method according to this embodiment leads to a second residue, which phorbol ester concentration is further reduced compared to the first residue, and no mortality is observed by the detoxified second residue according to the invention in the mollusk bioassay. Therefore, the phorbol ester concentration of the second residue is below the sensitivity range of the mollusk bioassay. Detection limit of the mollusk bioassay is about 10 fold lower than that of HPLC. Therefore, the second residue according to the invention is completely detoxified and can be safely included in human nutrition and animal feed.

In another embodiment the mollusk is a snail, preferably selected from the group consisting of Oncomelania hupensis, Biomphalaria glabrata and Bulinus globosus. These three snail species are especially suited for toxicity bioassays, because they are very sensitive to toxic substances, like phorbol esters, and they are easy to handle under laboratory and experimental conditions.

In an additional embodiment of the invention a dosage of the second residue per one mollusk is approximately 0.1 grams in the bioassay. One gram of the residue is extracted, and the extract is dried, dissolved in ethanol and diluted in one liter of water, which results in a preferred concentration for a mollusk bioassay.

In a further preferred embodiment carps (Cyprinus carpio) are used to evaluate the concentration of toxic substances and alimentary quality of the second residue, wherein no adverse effects are detected in carps fed with the second residue. Carps are species very sensitive to toxin, and are generally used for toxicological evaluations. Carps fed with the second residue according to the invention showed growth performance, blood parameters, hepatosomatic and spleen index as well as digestibility of dry matter and nutriment that were comparable with those of control groups. In addition, quantitative determinations of alanine amino transferase, lysine activity, total bilirubin content and ion levels in the blood of treated carps were within the normal range in fish and did not indicate any toxicity. The feeding of the second residue on carp did not produce any adverse effects in organs, like liver, intestine and muscle, and these organs were free of phorbol esters indicating that the fish is safe for human consumption. Therefore, the second residue according to the invention is completely detoxified and can be safely included in animal feed.

In a further preferred embodiment of the invention the phorbol ester concentration of the second residue is about 0.001 mg/g or less. The bioassay of a mollusk is very sensitive to detect phorbol esters in detoxified materials. In snails, phorbol esters at 0.001 mg/g cause 100% mortality. The second residue according to the invention showed a mortality of 0% in a bioassay of a mollusk and even no signs of toxicity in blood parameters and histopathology. Therefore, the measured concentration of phorbol ester is at least below 0.001 mg/g.

In the most preferred embodiment of the invention Jatropha is Jatropha curcas, preferably a toxic genotype of Jatropha curcas, or a cross of different Jatropha species, preferably of toxic genotypes of Jatropha curcas.

A preferred cross is a cross between Jatropha curcas and another Jatropha species, like Jatropha cathartica, Jatropha dhofarica, Jatropha glandulifera, Jatropha gossypiifolia, Jatropha integerrima, Jatropha macrantha, Jatropha macrorhiza, Jatropha mahafalensis, Jatropha malacophylla, and Jatropha multifida.

Jatropha curcas is a member of the genus Jatropha. Jatropha curcas is favorable species, because it is not grazed by animals, grows readily in poor and stony soil, is drought, pest and disease resistant, yields high quality biodiesel and is suitable to reclaim eroded land. Kernel of Jatropha curcas has an oil content close to 60%. Due to its fatty acid composition and physical parameters, oil from Jatropha curcas is markedly suited for production of biodiesel, wherein kernel meal remains as byproduct.

There are two genotypes of Jatropha curcas, a toxic one and a low-toxic one that is found only in Mexico. Approximately 25 to 30 million ha are currently cultivated, largely with the toxic genotype, since this genotype is considered to be more resistant to diseases and pests. The toxic genotype of Jatropha curcas includes a Cape Verde and a Nicaragua variety. The low-toxic genotype of Jatropha curcas includes a Mexican variety. Although the phorbol ester content in the kernel of the low-toxic genotype is lower (0.11 mg/g) compared to the toxic genotype (2.2-2.7 mg/g), the low phorbol ester concentration of the low-toxic genotype is still capable to elicit effects, like mucus in feces of animals fed by a diet containing constituents of the low-toxic genotype of Jatropha curcas, as well as subclinical effects (Makkar and Becker, 1997).

A comparison between the amino acid composition of Jatropha curcas meal and soybean meal revealed an almost similar pattern for all essential amino acids, except lysine and sulfur amino acids.

Due to the high levels of essential amino acids, the high protein content and high protein quality, the kernel meal of the toxic genotype from Jatropha curcas detoxified according to the invention is an excellent protein source for human nourishment as well as animal feed.

In a further embodiment of the invention the solvent comprises methanol at a concentration of about 70% to about 95%, preferably about 80% to about 90%, most preferably about 90%. Optimizations studies were conducted using various concentrations of methanol. Their results demonstrate that rising concentrations of methanol further decreased phorbol ester concentration in the residues according to the invention. The concentration of 90% methanol is found to reduce the phorbol ester concentration in the first and the second residue to maximum extend.

In another preferred embodiment of the invention the solvent comprises sodium hydroxide at a concentration of about 0.01 M to about 0.3 M, preferably about 0.05 M to about 0.2 M, most preferably about 0.1 M. The extraction of phorbol esters is maximal at 0.1 M NaOH. At higher NaOH concentrations loss in dry matter increased from 15% with 0.1 M NaOH to 25% with 0.3 M NaOH. The protein loss also increased with higher concentrations of NaOH.

In a further preferred embodiment of the invention a quantitative proportion of the plant constituent to the solvent is about 1:10 (w/v) in the mixture. In yet another preferred embodiment of the invention the quantitative proportion of the plant constituent to methanol is about 1:10 (w/v) in the blend.

Methanol was added to the Jatropha plant constituent in the ratio of 1:10 (w/v), which yields an optimal mixing ratio to detoxify the Jatropha plant constituent very effective.

In an also preferred embodiment of the invention heating is performed at a temperature of about 50° C. to about 70° C., preferably about 60° C. to about 70° C. The removal of phorbol esters was lowest at about 50° C. and identical at about 60° C. to about 70° C. Therefore, the temperature of about 60° C. to about 70° C. is the optimal range to remove phorbol esters from Jatropha constituents.

In a further embodiment the method according to the invention further comprises the step of washing the residue with methanol. The term “washing” as used herein includes overlaying the residue with methanol and subsequent drying by filtering, suction or decantation; mixing or elutriating the residue with methanol and subsequent separation; and spilling, pouring and rinsing the residue by methanol e.g. in combination with filtration. By the washing step the phorbol ester concentration in the Jatropha constituent is further reduced, whereby the detoxification process is again improved.

In yet another embodiment the method according to the invention further comprises the step of autoclaving the residue, preferably at a moisture of about 75%. During autoclaving, the residue is exposed to saturated steam at a required temperature for an appropriate time. In previous studies, autoclaving at 121° C. for 30 minutes at 66% moisture was used to inactivate lectins and trypsin inhibitors. However, in the present invention moisture was preferably increased to 75%, whereby the time for inactivation of lectins and trypsin inhibitors is reduced to 50% and content of lectin and trypsin inhibitors is further decreased to non-detectable levels.

In a third aspect the invention concerns a detoxified material of Jatropha obtainable by the method according to the invention for producing a nourishment, wherein Jatropha is a toxic or low-toxic genotype of Jatropha and the concentration of phorbol esters in the detoxified material is 3 ppm or less.

A fourth aspect of the invention concerns the use of the detoxified material according to the invention for producing a nourishment, preferably a feed for farm animals and aquacultures species.

Due to the crude protein content of approximately 60% and the high level of essential amino acids, the kernel meal from the toxic genotype of Jatropha species is a valuable constituent or raw material for feed and nourishment after detoxification according to the invention. Phorbol esters were not detected by the HPLC method in the Jatropha residue detoxified according to the invention, and the second residue of the invention elicited no mortality, no histopathological changes, blood pictures remained normal and organs, like liver, intestine and muscles, were free of phorbol esters as evaluated by mollusk or carp bioassays. Therefore, nourishment produced by using Jatropha constituents detoxified according to the invention is safe for human and animal consumption.

### EXAMPLES

The invention is further illustrated by two examples:

A) Method for Preparing Phobol-Ester Free Jatropha Kernel Meal

Materials and Methods

1. Removal of Phorbol Esters

Methanol containing NaOH was added to defatted kernel meal in a round bottom flask to obtain a mixture. The flask was heated with a refluxing unit fixed on it. After heating, the mixture was transferred on a Buchner funnel and filtered to obtain the residue. The filtrate was discarded, and the first residue was washed with methanol, and the washed residue was collected.

The washed residue was transferred into another round bottom flask, and methanol in the flask was added. Again the mixture was heated while the solvent was being refluxed. The mixture was filtered and washed with methanol as stated above, and the second residue was dried at room temperature by spreading the second residue.

After adjusting the moisture, the second residue was autoclaved and dried to obtain detoxified Jatropha kernel meal.

2. Development of the Detoxification Procedure

Development of the detoxification procedure involves removal of phorbol esters and inactivation of trypsin inhibitor and lectin.

Optimization studies were conducted using various concentration of methanol (70%, 80%, 90% and 95% aqueous methanol). 90% methanol was found to be the most effective concentration for removing phorbol esters. Methanol extractions were conducted at temperatures of 50° C., 60° C. and 70° C. during refluxing. The removal of phorbol esters was lowest at 50° C. and the same at 60° C. and 70° C. In addition, NaOH concentration was also changed from 0 M to 0.3 M. The extraction of phorbol esters reached saturation at 0.1 M NaOH. At higher NaOH concentrations loss in dry matter increased from 15% with 0.1 M NaOH to 25% with 0.3 M NaOH. The protein loss also increased with higher concentrations of NaOH.

3. Optimized Detoxification Procedure

Step A:

90% methanol (methanol:water=9:1) containing NaOH at a concentration of 0.1 M (0.4% NaOH in 90% methanol) was added to defatted kernel meal in a round bottom flask added in the ratio 1:10 (w/v) to obtain a mixture. The flask was heated for 30 min with a refluxing unit fixed on it; the temperature of the medium in the flask was 65-70° C. After heating for 30 min, the mixture was transferred on a Buchner funnel, filtered to obtain the residue, and the filtrate was discarded. The residue was washed with 90% methanol (volume of this solvent=1.2 times the weight of the kernel meal initially taken), and the washed residue was collected.

Step B:

The washed residue from step A was transferred into another round bottom flask, 90% methanol was added in the ratio of 1:10 (w/v) to obtain a mixture that was heated for 30 min while the solvent was being refluxed. The mixture was filtered and washed with 90% methanol as stated above in step A, and the residue was dried at room temperature by spreading.

The moisture was adjusted to a content of 75%, autoclaved at 121° C. for 15 min and dried to obtain detoxified Jatropha kernel meal.

Use of detoxification process as illustrated in step A and step B but without NaOH in step A produced a product containing 0.06 mg/g phorbol ester, suggesting that the use of NaOH during extraction with 90% methanol in step A is imperative.

4. Quantification of Phorbol Esters

Phorbol esters were determined at least in duplicate. 0.5 g of the samples was extracted four times with methanol. A suitable aliquot was loaded in a high-performance liquid chromatography (HPLC) reverse-phase C18 LiChrospher 100, 5·m (250×4 mm I.D. from Merck (Darmstadt, Germany). The column was protected with a head column containing the same material. The separation was performed at room temperature (23° C.) and the flow rate was 1.3 ml/min using a gradient elution. The four phorbol ester compound peaks were detected at 280 nm and appeared between 25 and 30.5 min. The spectra were taken using Merck-Hitachi L-7450 photodiode array detector. The results are expressed as equivalent to phorbol-12-myristate 13-acetate, which appeared between 31 and 32 min (Makkar et al., 1997).

5. Inactivation of Trypsin Inhibitor and Lectin

Water was added to the kernel meals obtained at step A or step B to bring the moisture level to 75%. The moistened meal was then autoclaved at 121° C. for 15 min. Trypsin inhibitor activity was determined (Makkar et al., 1997). Analysis of the lectin content was conducted by hemagglutination assay in round-bottomed wells of microtitre plates using 1% (v/v) trypsinized cattle blood erythrocytes suspension in saline phosphate buffer, pH 7.0 (Makkar et al., 1997).

6. Evaluation of Jatropha Kernel Meal Using Snails as a Bioassay

Snails have been found to be highly sensitive to phorbol esters. At 1 ppm of phorbol esters, 100% mortality has been observed by us (Goel et al., 2007). Snails were used as a bioassay to confirm the absence of phorbol esters in the kernel meal obtained at step A and step B.

The molluscicidal activity was carried out according to the protocols (Feitosa dos Santos and Sant'Ana, 1999) and (Liu et al., 1997) with slight modifications. The protocol basically involved the immersion of snails in an aqueous solution of the substance under investigation at appropriate concentrations. The extracts from 1 g Jatropha kernel meal obtained from step A and B were pooled and dried with a final volume of 1 ml in ethanol. Ten snails were taken (snail to water ratio was 1:25 ml) and the bioassay was performed in triplicate. The exposure time of these organisms was 24 h. After this time, the snails were washed, placed in dechlorinated water and fed with lettuce, left under observation for 72 h. Dead snails were collected and counted. The snail mortality was indicated by discoloration, absence of muscle contraction, haemorrhage and deterioration of the body tissues.

Two control sets were used in order to verify the snail susceptibility: one with 1 ml of ethanol and the second consisting of dechlorinated water alone. No mortality of snails was observed in these two controls, suggesting that any mortality observed using the extracts obtained from step A and step B materials is due to the presence of phorbol esters.

7. In Vivo Evaluation of Detoxified Seed Meal, Using Fish as a Model

7.1 Experimental System and Animals

Carp (Cyprinus carpio) fingerlings (about 2.0-3.0 g) used to evaluate the quality of the detoxified kernel meal as a protein supplement and the fish were kept in two 500 l capacity tanks for acclimatization. They were fed the Hohenheim standard fish diet containing approximately 38% protein, 8% lipid, 10% ash and a gross energy content of 20 kJ/g dry matter. After an acclimatization period of 20 days, 252 fish were randomly distributed into seven groups with four replicates. Each replicate contained nine fish (av. wt. 3.2 g) in an aquarium (25 l capacity). All aquaria were supplied with water at 27±0.5° C. from a recirculation system. The system was subjected to a photoperiod of 12 h light:12 h darkness. Water quality was monitored throughout the experiment. All water parameters were in the optimum range (temperature 26.2-27.1° C., pH 7.0-7.5, dissolved oxygen 6.9-7.4 mg/l, total NH3 0.1-0.2 mg/l, nitrite 0.07-0.1 mg/l and nitrate 1-3 mg/l). Water flow was adjusted to keep the oxygen saturation above 80%. The given feeds were dispensed using an automatic feeder. Fish were weighed individually at the beginning of the experiment (av. wt. 3.2 g) and at weekly intervals during the experimental period to adjust the feeding level for the subsequent week. The fish were not fed on the weighing day. During the last 2 weeks of the experiment, fish were fed with a marker (TiO₂) for digestibility measurement. Fecal matter was collected during the last two weeks of experiment twice a day. During the experiment there was no mortality. At the start of the experiment, 18 fish of the same population were killed and preserved at ·20° C. for the analysis of the initial body composition.

The experiment was terminated after 8 weeks, and the fish were sacrificed. At the end of the experiment, fish were anesthetized by tricaine methanesulfonate (MS222) at 250 ppm in water. Blood was drawn near caudal peduncle from two fish from each replicate and transferred into a heparinized tube. Blood from one fish was used for hematological study, and the other was centrifuged at 1500×g for 5 min at room temperature (24° C.) to obtain plasma, which was then stored at ·20° C. for determination of cholesterol and triglycerides. Blood was drawn from one fish per replicate for serum collection. Serum was stored at ·20° C. for lysozyme determination. Two fish per replicate were carefully dissected to isolate liver, intestine, muscles and kidney and stored in liquid nitrogen for further enzyme assay. Two fish per replicate were stored at ·20° C. for chemical composition analysis. Prior to the determination of the proximate composition, the fish were autoclaved at 121° C. for 20 min, thoroughly homogenized using an Ultra-Turrax T25, frozen overnight and freeze-dried.

7.2 Diet Formulation

Fishmeal and wheat meal were purchased from Kurt Becker GmbH, Bremen, Germany, and a local market respectively. Defatted soybean meal was obtained from Institute of Animal production system (480a), University of Hohenheim, Germany. Prior to feed formulation, the proximate composition of defatted Jatropha meal, wheat meal, soybean meal, soya concentrate and fishmeal were determined. A total of seven isonitrogenous and isoenergetic diets were formulated. Experimental diets containing crude protein 38%, crude lipid 8%, vitamin premix 2%, mineral premix 2% and TiO₂ 1% were prepared. The inclusion levels of the Jatropha meal and soybean meal were as follows: Control diet (T₁) was prepared with fishmeal and wheat meal, without any Jatropha meal and soybean meal. T₂: 50% fishmeal protein replaced by soybean meal (S₅₀); T₃: 75% fishmeal protein replaced by soybean meal (S₇₅); T₄: 50% fishmeal protein replaced by Jatropha meal (Jₐ₅₀); T₅: 75% fishmeal protein replaced by Jatropha meal (Jₐ₇₅); T₆: 50% fishmeal protein replaced by Jatropha meal (J_{b50}); T₇: 75% fishmeal protein replaced by Jatropha meal (J_{b75}). The final mixture of each diet was made into 2 mm diameter moist pellets and then freeze-dried (Table 1). Jatropha meal Jₐ and J_{b} were the detoxified Jatropha kernel meals at step A and step B, respectively.

TABLE 1
Composition of the experimental diets (g/kg feed)

| | Experimental diets | | | | | | |
|---|---|---|---|---|---|---|---|
| Ingredients | Control | S₅₀ | S₇₅ | Jₐ₅₀ | Jₐ₇₅ | J_{b50} | J_{b75} |
| Fish meal | 507.5 | 253.7 | 126.3 | 253.7 | 126.3 | 253.7 | 126.3 |
| Soybean meal | — | 342.1 | 513 | — | — | — | — |
| Wheat flour | 402.5 | 271 | 206 | 381.5 | 372 | 390 | 384.1 |
| Jatropha meal | — | — | — | 249.5 | 372 | 242.5 | 361.9 |
| Soya concentrate | — | 22 | 32 | 3.5 | 7 | 2 | 5 |
| Sunflower oil | 40 | 61.2 | 72.7 | 61.8 | 72.7 | 61.8 | 72.7 |
| Vitamin premix | 20 | 20 | 20 | 20 | 20 | 20 | 20 |
| Mineral premix | 20 | 20 | 20 | 20 | 20 | 20 | 20 |
| TiO₂ | 10 | 10 | 10 | 10 | 10 | 10 | 10 |
| Total | 1000 | 1000 | 1000 | 1000 | 1000 | 1000 | 1000 |
| Phytase (FTU) | — | 500 | 500 | 500 | 500 | 500 | 500 |
| Lysine (g) | — | — | — | 2.5 | 3.7 | 2.4 | 3.6 |

7.3 Biochemical Analysis

The proximate composition of diet ingredients, diets and whole body of fish was determined using the standard methods of the Association of Official Analytical Chemists (AOAC). Samples of animal origin (fish bodies and fish meal) were analyzed for dry matter (DM), ash, crude protein (CP) and lipid (ether soluble lipid). Gross energy (GE) of diet ingredients, diets and fish bodies was determined with bomb calorimeter using benzoic acid as a standard.

7.4 Growth Parameters

Growth performance and diet nutrient utilization were assessed in terms of body mass gain (BMG), specific growth rate (SGR), metabolic growth rate (MGR), feed conversion ratio (FCR) and protein productive value (PPV). These were calculated as follows (Dongmeza et al., 2006):

BMG=final body mass−initial body mass

BMG(%)=[(final body mass−initial body mass)/Initial body mass]×100

SGR=[(In final body mass in g)−In initial body mass in g)/number of trial days]×100

MGR=(body mass gain in g)/[{(initial body mass in g/1000)^{̂0.8}+(final body mass in g/1000)̂^{0.8}}/2]/number of trial days

FCR=dry feed fed (g)/body mass gain (g)

PPV(%)=[(final fish body protein in g−initial fish body protein in g)/total protein consumed in g]×100

ER(%)=[(final fish body energy−initial fish body energy)/(gross energy intake)]×100

PER=fresh body mass gain (g)/crude protein fed (g)

7.5 Digestibility Measurement

Apparent digestibility coefficients (ADCs) and digestibility of dry matter expressed as percentage were calculated using the following formula:

Apparent dry matter digestibility(%)=[1−{(% TiO₂ in feed)/(% TiO₂ in feces)}]×100

The nutrient digestibility was obtained using the following formula:

Apparent nutrient digestibility(%)=[1−{(% TiO₂ in feed)/(% TiO₂ in feces)×(% TiO₂ in feces)/(% TiO₂ in feed)}]×100

7.6 Hepatosomatic Index (HI), Intestinal Somatic Index (ISI) and Spleen Index (SI)

HSI, ISI and ISI were calculated as indicated below (Adams et al., 2003): HSI=Liver mass (g)/body mass (g); ISI=Intestine mass (g)/body mass (g); SI=Spleen mass (g)/body mass (g)

7.7 Blood Chemistry (Hematoimmunological Parameters)

Total erythrocyte count (RBC) and total leukocyte count (WBC) were counted by Neubauer's counting chamber of hemocytometer. Care was taken to avoid trapping of air bubbles. The RBC lying inside the five small squares were counted under high power (40×) of light microscope.

The following formula was used to calculate the number of RBC per mm³ of the blood sample:

Number of RBC/mm³=(N×dilution)/Area counted×Depth of fluid

From analyses of Hct, Hb and RBC, the following parameters were calculated:

mean cell volume, MCV=(Hct/RBC)×10); mean cell hemoglobin, MCH=(Hb/RBC)×10) and mean cell hemoglobin concentration, MCHC=(Hb/Hct)×100.

The hemoglobin content of blood was analyzed by Reflotron Hemoglobin test (REF 10744964, Roche diagnostic GmbH, Mannheim, Germany). Hematocrit was determined on the basis of sedimentation of blood. Heparinized blood (50·l) was taken in the hematocrit capillary (Na-heparinized) and centrifuged in the Hematocrit 210 Hettich Centrifuge (Tuttlingen Germany) to obtain hematocrit value.

Lysozyme activity of serum was measured by EnzChek Lysozyme Assay Kit (E-22013) Leiden, The Netherlands. The assay measures lysozyme activity on Micrococcus lysodeikticus cell walls, which are labeled to such a degree that the fluorescence is quenched. Lysozyme action relieves this quenching, yielding a dramatic increase in fluorescence that is proportional to lysozyme activity. The fluorescence increase was measured by using a spectrofluorometer that detect fluorescein. Lysozyme hydrolyzes ·-(1-4)-glucosidic linkages between N-acetylmuramic acid and N-acetyl-D-glucosamine residues present in the muco-polysaccharide cell well of a variety of microorganisms.

The VetScan® Comprehensive Diagnostic Profile reagent rotor used with the VetScan Chemistry Analyzer (Scil Animal Care Company GmbH, Technischer Service, Germany) utilized dry and liquid reagents and provided quantitative determinations of alanine aminotransferase (ALT), albumin, alkaline phosphatase (ALP), total calcium (Ca⁺⁺), creatinine, globulin, glucose, phosphorus, potassium (K⁺), sodium (Na⁺), total bilirubin (TBIL) and total protein in heparinized whole blood.

Survival (%)=(Total number of fish harvested/Total number of fish stocked)×100. Gut, liver, kidney and spleen sections were cut and stained using hematoxylin and Eosin stain.

All data were subjected to a one-way analysis of variance ANOVA and the significance of the differences between means was tested using Duncan's multiple range test (P<0.05). The software used was SAS, Version 9.1 (Statsoft Inc., Tulsa, USA). Values are expressed as means±standard deviation.

Results and Detailed Description of the Figures.

1. Phorbol Ester Detoxification

The HPLC chromatogram of untreated Jatropha curcas kernel meal is presented in FIG. 1. The four peaks between 25 and 30 min of elution represent phorbol esters. The amount of phorbol esters present was 2.5 mg/g.

The HPLC chromatograms of Jatropha meal obtained after step A (FIG. 2) and step A together with step B (FIG. 3) show none of the phorbol ester peaks observed in FIG. 1.

To determine the repeatability of the method the phorbol ester content was analyzed 11 times on a sample spiked with 2.5 mg/g phorbol esters. The average measured phorbol ester content was 2.55 mg/g with a standard deviation of 0.07 mg/g and a relative deviation of 2.75%.

In conclusion, Jatropha kernel meals obtained after step A or step B combined with step A were free of phorbol esters, as determined by the HPLC method.

2. Inactivation of Trypsin Inhibitor and Lectin

In earlier studies, trypsin inhibitor and lectin were inactivated by heating at 121° C. for 30 in at 66% moisture (Makkar and Becker, 1997). According to the invention the water level was increased to 75%. This reduced duration to inactivate trypsin inhibitor and lectin to 50% (15 min). In conclusion, the heat treated kernel meals are free of trypsin inhibitor and lectin activities (Table 2).

TABLE 2
Trypsin inhibitor and lectin activity
of the unheated and heated kernel meals

| Treatments | Trypsin inhibitor activity^{a} | Lectin activity^{b} |
|---|---|---|
| Unheated | 22.3 | 102 |
| step A (30 min treatment) | ND | ND |
| step B (60 min treatment) | ND | ND |

ND, not detected;
^{a}mg trypsin inhibited per g sample
^{b}1/mg of meal that produced hemagglutination per ml of assay medium

3. Evaluation of Jatropha Kernel Meal Obtained Using Snails as a Bioassay

No mortality of snails was observed by the extract obtained from the material obtained at step B (60 min treatment). Mortality of only 10% to 20% was observed by the extract obtained from the material obtained at step A (Table 3).

TABLE 3
Snail mortality by the extracts from the treated kernel meal

| Treatment | Mortality (%)* |
|---|---|
| step A (30 min treatment) extract | 10, 10, 20 |
| step B (60 min treatment) extract | 0, 0, 0 |

*Assay performed in triplicate

Even though the detoxified kernel meal obtained at step A was free of phorbol esters as judged by HPLC, it does have small amounts of phorbol esters, which were below the sensitivity range of the HPLC. The presence and activity of these small amounts was shown by the sensitive snail bioassay. Even this sensitive assay did not detect toxic effects elicited by kernel meal obtained at step B.

In conclusion, the material obtained at step B (60 min) treatment is free of phorbol esters.

4. In Vitro Evaluation of the Detoxified Kernel Meal

The kernel meal obtained at step B (60 min treatment) was evaluated for: a) amino acid analysis, b) available lysine value, and c) protein digestibility parameters.

The contents of amino acids and available lysine were determined, and in vitro protein digestibility was determined by treatment with pepsin, followed by treatment with trypsin, using the procedure of Saunders et al. (1972).

4.1 Amino Acid Content

The crude protein contents of the untreated kernel meal were 60.3% and that of the detoxified kernel meal (step B) was 63.0%. Amino acid levels are presented in Table 4.

The contents of available lysine in untreated and detoxified kernel meal of step B were 3.75 mg/100 mg protein and 3.82 mg/100 mg protein. The available lysine was determined using the trinitrobenzene sulfonic acid (TNBS) reagent, and we have found that the levels of available lysine by this method to be higher than that of total lysine determined using the amino acid analyzer. It is important that the available lysine value for the detoxified kernel meal should not be lower than for the untreated kernel meal. From these results it is evident that the detoxification process did not decrease the available lysine.

TABLE 4
Amino acid composition (g/16 g nitrogen) of untreated
kernel meal and detoxified kernel meal (step B)

| | | | | FAO (ref pro- |
|---|---|---|---|---|
| | Untreated | Detoxified | Soybean | tein for a |
| Aminoacids | kernel meal | kernel meal | meal | growing child) |
| Essential | | | | |
| Methionine | 1.84 | 1.55 | 1.22 | 2.50 |
| Cystine | 1.51 | 1.36 | 1.70 | |
| Valine | 4.25 | 3.85 | 4.59 | 3.50 |
| Isoleucine | 3.98 | 3.90 | 4.62 | 2.80 |
| Leucine | 6.84 | 6.59 | 7.72 | 6.60 |
| Phenylalanine | 4.07 | 3.78 | 4.84 | 6.30 |
| Tyrosine | 2.99 | 2.49 | 3.39 | |
| Histidine | 3.08 | 2.32 | 2.50 | 1.90 |
| Lysine | 3.60 | 3.36 | 6.08 | 5.80 |
| Arginine | 11.8 | 9.46 | 7.13 | |
| Threonine | 3.38 | 2.53 | 3.76 | 3.40 |
| Tryptophan | 1.31 | ND | 1.24 | 1.10 |
| Non-essential | | | | |
| Serine | 4.65 | 3.81 | 5.67 | — |
| Glutamic acid | 12.99 | 12.59 | 16.90 | — |
| Aspartic acid | 11.41 | 8.28 | 11.30 | — |
| Proline | 4.01 | 3.12 | 4.86 | — |
| Glycine | 4.32 | 3.29 | 4.01 | — |
| Alanine | 4.51 | 3.99 | 4.23 | — |

ND, Not determined

4.2 In Vitro Protein Digestibility

Table 5 shows pepsin and pepsin plus trypsin digestibility of the untreated and detoxified kernel meal (step B).

TABLE 5
Pepsin and pepsin plus trypsin digestibility of the
untreated and detoxified (step B) kernel meals

| | | Pepsin plus trypsin di- |
|---|---|---|
| Treatments | Pepsin digestibility (%) | gestibility (%) |
| Untreated kernel meal | 90.8 | 95.2 |
| Detoxified kernel meal | 72.9 | 85.8 |

The detoxification treatment decreases slightly the protein availability when compared to the untreated kernel meal. However, the protein digestibility of the detoxified kernel meal is high and is of the same order as for soymeal, ground nut meal and other conventional seed meals.

5. In Vivo Evaluation of Detoxified Seed Meal, Using Fish as a Model

Carp (Cyprinus carpio) was used to evaluate the quality of the detoxified kernel meal as a protein supplement and the toxicity, if any, on feeding diets containing the detoxified kernel meal obtained from step A and step B. Carp was chosen since it is one of the most sensitive species and is generally used in toxicological evaluation of various compounds (Dembele et al. 2000). Becker and Makkar, 1998 has also shown that carp is highly sensitive to Jatropha phorbol esters and can detect them at a level of 15 ppm in diet.

5.1 Proximate Composition of Experimental Diet and Whole Body

The proximate composition of the different experimental diets (% dry matter) and whole body tissue (wet basis %) is presented in Tables 6 and 7, respectively. Diets contained about 38% crude protein and 18.5 kJ/g gross energy and were isonitrogenous and isocaloric. Dry matter, crude lipid and ash were in the range of 94.4-96.1%, 8.3-8.8% and 10.3-11.1%, respectively. There was no significant difference (P>0.05) in moisture content, crude protein and ash of the whole body among the groups. Highest crude lipid deposition was observed in J_{b75} group, which is statistically similar (P>0.05) to all plant protein fed groups (except Jₐ₇₅ group), whereas lowest lipid deposition was observed in Jₐ₇₅ and control groups. Generally the whole body fat content increased with the use of dietary plant proteins, which could be due to imbalance in the amino acid concentrations in the diet or, to the higher content of starch in plant protein sources, which could get converted to lipid in the body by lipogenesis.

TABLE 6
Proximate composition of experimental diets (% dry
matter basis except Gross energy which was kJ/g)

| | | Crude | Crude | Gross energy | |
|---|---|---|---|---|---|
| Treatment | Dry matter | protein | lipid | (kJ/g) | Ash |
| Control | 94.8 | 38.5 | 8.7 | 18.4 | 10.5 |
| S₅₀ | 94.4 | 38.3 | 8.3 | 18.7 | 11.0 |
| S₇₅ | 94.9 | 38.2 | 8.5 | 19.4 | 10.3 |
| Jₐ₅₀ | 94.8 | 38.4 | 8.6 | 18.6 | 10.8 |
| Jₐ₇₅ | 95.4 | 38.5 | 8.6 | 18.5 | 11.1 |
| J_{b50} | 96.1 | 38.1 | 8.8 | 18.2 | 10.2 |
| J_{b75} | 94.9 | 38.2 | 8.7 | 18.4 | 10.0 |

TABLE 7
Chemical composition of body tissue of Cyprinus carpio fingerlings (%
fresh basis except Gross energy which was kJ/g fresh weight) of different
experimental groups at the start and at the end of the experiment

| Treatment | Moisture | Crude protein | Crude lipid | Ash | Gross energy |
|---|---|---|---|---|---|
| Initial fish | 79.6 ± 0.06 | 13.3 ± 0.05 | 3.0 ± 0.01 | 4.4 ± 0.03 | 4.8 ± 0.03 |
| Control | 76.6 ± 0.64 | 14.6 ± 0.52 | 4.9^{b} ± 0.23 | 2.2 ± 0.11 | 5.8^{a} ± 0.16 |
| S₅₀ | 78.2 ± 1.15 | 14.5 ± 1.03 | 5.1^{ab} ± 1.10 | 2.4 ± 0.13 | 4.9^{b} ± 0.51 |
| S₇₅ | 78.6 ± 2.10 | 14.4 ± 1.49 | 5.7^{ab} ± 0.48 | 2.2 ± 0.28 | 5.0^{b} ± 0.43 |
| Jₐ₅₀ | 77.8 ± 1.88 | 15.1 ± 0.51 | 5.7^{ab} ± 1.78 | 2.3 ± 0.20 | 5.2^{ab} ± 0.83 |
| Jₐ₇₅ | 78.6 ± 0.70 | 15.0 ± 0.27 | 5.0^{b} ± 0.61 | 2.2 ± 0.07 | 4.9^{b} ± 0.26 |
| J_{b50} | 76.9 ± 1.05 | 15.7 ± 0.24 | 6.6^{ab} ± 1.07 | 2.2 ± 0.06 | 5.9^{a} ± 0.22 |
| J_{b75} | 76.8 ± 0.56 | 15.3 ± 0.31 | 6.9^{a} ± 0.78 | 2.2 ± 0.19 | 5.5^{ab} ± 0.23 |
| SEM | 0.28 | 0.14 | 0.21 | 0.03 | 0.11 |

Mean values in the same column with different superscript differ significantly (P < 0.05).

5.2 Fish Behavior and Feed Intake

Based on the visual observation during feeding time, palatability or acceptability of feed was good, and the behavior of fish was normal. There was no mortality during the entire experimental period.

It was particularly noted that the fish of the groups Jₐ₇₅ (step A detoxified meal replaced at 75% level) fed very slowly on their feed. Sometimes they ingested the feed pellets and spit them out after a few seconds and they repeated this 2 to 3 times before finally ingesting and swallowing the pellets, whereas fish in all other dietary groups fed actively on the experimental diets throughout the experiment.

5.3 Growth Performance and Feed Utilization

Weekly weight gains of fish are given in FIG. 8. The growth performance of the fish at the end of the experimental period and the nutrient utilization are presented in Tables 8 and 9. Highest body weight gain (BWG %), specific growth rate (SGR %) and energy retention (ER %) were observed for the J_{b50} group, which were significantly similar to that for control group and significantly (P<0.05) higher than for all other groups. Highest ER % in J_{b50} group indicates the highest gross energy content of the whole body. Lowest feed conversion ratio (FCR) (lower the FCR, higher is the feed conversion efficiency) was observed in control group, which is statistically similar to J_{b50} group. Lowest metabolic growth rate (MGR), protein efficiency ratio (PER) and protein productive value (PPV) were observed in Jₐ₇₅ group. This group had lowest growth rate as well. Except for J_{b50} group, we found an only slight decrease of various growth and assimilation parameters (decrease in BWG, MGR, PER, PPV, and ER; and increase in FCR) in the fish fed diets containing increasing levels of plant protein in the diet.

TABLE 8
Initial body mass (IBM), final body mass (FBM) and body mass gain
(BMG) of Cyprinus carpio fed experimental diets for 8 weeks

| Treatment | IBM (g) | FBM (g) | BMG (g) |
|---|---|---|---|
| Control | 3.2 ± 0.1 | 32.0^{a} ± 1.96 | 28.9^{a} ± 1.95 |
| S₅₀ | 3.3 ± 0.1 | 30.6^{ab} ± 0.72 | 27.3^{ab} ± 0.68 |
| S₇₅ | 3.2 ± 0.1 | 27.7^{c} ± 10.57 | 24.5^{c} ± 0.64 |
| Jₐ₅₀ | 3.2 ± 0.1 | 24.9^{d} ± 3.31 | 21.7^{d} ± 3.24 |
| Jₐ₇₅ | 3.3 ± 0.0 | 20.9^{e} ± 2.04 | 17.7^{e} ± 2.03 |
| J_{b50} | 3.2 ± 0.1 | 33.3^{a} ± 0.64 | 30.1^{a} ± 0.63 |
| J_{b75} | 3.2 ± 0.1 | 28.3^{bc} ± 1.21 | 25.1^{bc} ± 1.25 |
| SEM | 0.01 | 0.88 | 0.88 |

Mean values in the same column with different superscript differ significantly (P < 0.05).

TABLE 9
Growth performance and nutrient utilization of
Cyprinus carpio fed experimental diets for 8 weeks

| Treatment | BWG | SGR | FCR | MGR |
|---|---|---|---|---|
| Control | 917.0^{a} ± 59.63 | 4.1^{ab} ± 0.11 | 1.00^{b} ± 0.05 | 19.1^{ab} ± 0.30 |
| S₅₀ | 826.8^{b} ± 25.95 | 4.0^{bc} ± 0.05 | 1.06^{ab} ± 0.02 | 18.3^{ab} ± 0.27 |
| S₇₅ | 758.1^{bc} ± 39.13 | 3.8^{cd} ± 0.08 | 1.02^{b} ± 0.02 | 17.9^{ab} ± 0.31 |
| Jₐ₅₀ | 684.7^{c} ± 90.12 | 3.7^{d} ± 0.21 | 1.06^{ab} ± 0.03 | 17.3^{b} ± 0.90 |
| Jₐ₇₅ | 542.8^{d} ± 61.53 | 3.3^{e} ± 0.18 | 1.15^{ab} ± 0.03 | 16.5^{b} ± 0.76 |
| J_{b50} | 946.9^{a} ± 26.34 | 4.2^{a} ± 0.05 | 1.01^{b} ± 0.02 | 19.0^{ab} ± 0.20 |
| J_{b75} | 774.0^{bc} ± 58.23 | 3.9^{cd} ± 0.12 | 1.21^{a} ± 0.24 | 21.4^{a} ± 6.01 |
| SEM | 27.24 | 0.06 | 0.02 | 0.51 |

| Treatment | PER | PPV | ER |
|---|---|---|---|
| Control | 2.6^{a} ± 0.12 | 38.8^{ab} ± 2.41 | 30.1^{a} ± 1.91 |
| S₅₀ | 2.5^{ab} ± 0.06 | 38.0^{ab} ± 1.87 | 24.2^{b} ± 2.64 |
| S₇₅ | 2.6^{a} ± 0.05 | 37.4^{ab} ± 4.06 | 23.2^{b} ± 2.00 |
| Jₐ₅₀ | 2.4^{ab} ± 0.08 | 37.7^{ab} ± 1.97 | 24.1^{b} ± 4.76 |
| Jₐ₇₅ | 2.3^{b} ± 0.05 | 34.7^{b} ± 0.95 | 20.8^{b} ± 1.33 |
| J_{b50} | 2.6^{a} ± 0.04 | 41.3^{a} ± 0.88 | 29.5^{a} ± 0.93 |
| J_{b75} | 2.2^{b} ± 0.37 | 34.4^{b} ± 5.56 | 23.3^{b} ± 4.01 |
| SEM | 0.04 | 0.71 | 0.82 |

Mean values in the same column with different superscript differ significantly (P < 0.05).
BWG (%)—Body weight gain, SGR (%)—Specific growth rate and FCR—Feed conversion ratio; MGR (gkg^{0.8}/day)—Metabolic growth rate, PER—Protein efficiency ratio, PPV (%)—Protein productive value and ER (%)—Energy retention

The growth performance of J_{b50} and control and of J_{b75} and S₇₅ were similar; whereas that of Jₐ₅₀ and Jₐ₇₅ were lower than of control (FIG. 4).

5.4 Dry Matter and Nutrient Digestibility

The digestibility of dry matter and nutrients of different experimental diets are given in Table 10. The dry matter, nutrient and energy digestibility were somewhat lower in Jₐ₅₀ and Jₐ₇₅ groups. No such difference was noticed for J_{b50}, J_{b75} and soymeal supplemented groups. Another interesting point to note is that the protein and energy digestibility were statistically similar (P>0.05) for control and J_{b50} groups. These values were highest, suggesting good utilization of protein and energy from the detoxified Jatropha meal (obtained at step B), when supplemented in the diet at 50% replacement of fish meal protein. This is also reflected in high PER and ER values for this group, which were comparable with those of control group (Table 9).

TABLE 10
Effects of experimental diets on the dry matter and nutrient
digestibility (%) of Cyprinus carpio fingerlings

| | Dry matter di- | Protein di- | Lipid di- | Energy di- |
|---|---|---|---|---|
| Treatment | gestibility | gestibility | gestibility | gestibility |
| Control | 84.4^{a} ± 0.40 | 92.3^{a} ± 0.45 | 97.2^{a} ± 0.68 | 87.7^{a} ± 1.33 |
| S₅₀ | 81.3^{c} ± 0.45 | 91.3^{b} ± 0.31 | 94.0^{b} ± 0.82 | 83.6^{b} ± 0.51 |
| S₇₅ | 77.9^{d} ± 0.29 | 88.6^{c} ± 0.71 | 92.5^{c} ± 1.11 | 82.8^{b} ± 1.47 |
| Jₐ₅₀ | 73.1^{f} ± 0.73 | 87.7^{d} ± 0.75 | 89.7^{d} ± 0.74 | 77.9^{c} ± 3.14 |
| Jₐ₇₅ | 74.8^{e} ± 0.93 | 87.3^{d} ± 0.94 | 89.2^{d} ± 1.31 | 78.0^{c} ± 2.84 |
| J_{b50} | 82.5^{b} ± 0.25 | 92.2^{a} ± 0.39 | 95.0^{b} ± 0.91 | 87.6^{a} ± 1.11 |
| J_{b75} | 80.6^{c} ± 0.12 | 90.6^{b} ± 0.07 | 92.1^{c} ± 0.90 | 83.1^{b} ± 0.95 |
| SEM | 0.74 | 0.39 | 0.53 | 0.78 |

Mean values in the same column with different superscript differ significantly (P < 0.05).

5.5 Spleen, Hepatosomatic and Intestinal Somatic Index

There was no significant difference in intestinal somatic index (ISI) amongst the different groups. Although some significant, but minor differences were observed in hepatosomatic index (HSI) and spleen index, these do not indicate toxicity (Table 11).

TABLE 11
Effects of experimental diets on the spleen index,
hepatosomatic index (HSI) and intestinal somatic index
(ISI) of Cyprinus carpio fingerlings

| Treatment | Spleen index | HSI | ISI |
|---|---|---|---|
| Control | 0.16^{ab} ± 0.02 | 2.12^{b} ± 0.03 | 2.99 ± 0.26 |
| S₅₀ | 0.16^{ab} ± 0.01 | 2.26^{ab} ± 0.06 | 3.06 ± 0.15 |
| S₇₅ | 0.18^{a} ± 0.01 | 2.36^{a} ± 0.12 | 3.23 ± 0.56 |
| Jₐ₅₀ | 0.15^{b} ± 0.01 | 2.20^{b} ± 0.05 | 3.07 ± 0.17 |
| Jₐ₇₅ | 0.17^{a} ± 0.02 | 2.23^{ab} ± 0.10 | 3.12 ± 0.34 |
| J_{b50} | 0.16^{ab} ± 0.01 | 2.24^{b} ± 0.04 | 3.08 ± 0.03 |
| J_{b75} | 0.16^{ab} ± 0.02 | 2.35^{a} ± 0.07 | 3.09 ± 0.36 |
| SEM | 0.01 | 0.02 | 0.05 |

Mean values in the same column with different superscript differ significantly (P < 0.05).

5.6 Blood Parameters and Histopathology

The erythrocyte count (RBC), hemoglobin content (Hb), hematocrit (Hct), mean corpuscular volume (MCV), mean corpuscular hemoglobin (MCH) and mean corpuscular hemoglobin concentration (MCHC) are given in Table 12. These values were within the normal range in fish and do not indicate any toxicity.

Enzyme activities in blood are shown in Table 13. ALP level rises during bile duct obstruction and in intrahepatic infiltrative diseases of the liver. In our study ALP activities in Jₐ₇₅ and S₇₅ groups were statistically similar, and these values were significantly higher, when compared with those of other groups. Higher ALP activity in Jₐ₇₅ and S₇₅ groups might be an indication of liver dysfunction. It is surprising that high ALP activity was observed in S₇₅ group, which is a soybean meal containing diet.

TABLE 12
Effects of experimental diets on the hematological parameters
(RBC (10⁶ cells/mm³), WBC (10⁵ cells/mm³), Hb (g/dl),
Hct (%), MCV (fL), MCH (pg), MCHC (g/dl) of Cyprinus carpio

| Treatment | RBC | WBC | Hb | Hct | MCV | MCH | MCHC |
|---|---|---|---|---|---|---|---|
| Control | 1.58^{b} ± 0.10 | 1.43 ± 0.07 | 5.00 ± 0.00 | 29.75 ± 2.73 | 189.3^{ab} ± 4.16 | 31.8^{ab} ± 1.99 | 17.14 ± 2.79 |
| S₅₀ | 1.71^{ab} ± 0.08 | 1.73 ± 0.08 | 5.00 ± 0.00 | 32.25 ± 1.89 | 189.5^{ab} ± 18.53 | 29.3^{ab} ± 1.35 | 15.54 ± 0.87 |
| S₇₅ | 1.87^{a} ± 0.07 | 1.75 ± 0.07 | 5.00 ± 0.00 | 27.50 ± 5.00 | 147.6^{b} ± 7.32 | 26.8^{b} ± 0.97 | 18.63 ± 1.32 |
| Jₐ₅₀ | 1.67^{ab} ± 0.16 | 1.65 ± 0.16 | 5.48 ± 0.96 | 30.00 ± 2.57 | 179.6^{ab} ± 13.48 | 33.1^{a} ± 7.07 | 19.30 ± 1.02 |
| Jₐ₇₅ | 1.87^{a} ± 0.03 | 1.60 ± 0.03 | 5.00 ± 0.00 | 31.75 ± 1.71 | 170.0^{ab} ± 8.03 | 26.8^{b} ± 0.47 | 15.78 ± 0.83 |
| J_{b50} | 1.74^{ab} ± 0.20 | 1.50 ± 0.08 | 5.00 ± 0.00 | 35.25 ± 5.74 | 205.3^{a} ± 43.06 | 29.1^{ab} ± 3.37 | 14.52 ± 2.73 |
| J_{b75} | 1.85^{a} ± 0.13 | 1.85 ± 0.11 | 5.22 ± 0.43 | 31.75 ± 8.54 | 172.0^{ab} ± 7.61 | 28.2^{ab} ± 0.74 | 17.60 ± 1.93 |
| SEM | 0.03 | 0.13 | 0.07 | 1.02 | 6.61 | 0.67 | 0.70 |

Mean values in the same column with different superscript differ significantly (P < 0.05);
MCH: Mean corpuscular volume (pg);
MCHC: Mean corpuscular hemoglobin concentration (g/dl)

TABLE 13
Effects of experimental diets on alkaline phosphatase
(U/l), alanine transaminase (U/l) and amylase (U/l)
in blood of Cyprinus carpio fingerlings

| Treatment | ALP | ALT |
|---|---|---|
| Control | 84.75^{b} ± 55.1 | 92.00^{a} ± 6.63 |
| S₅₀ | 106.5^{ab} ± 51.8 | 76.75^{ab} ± 10.3 |
| S₇₅ | 159.25^{a} ± 67.5 | 71.25^{b} ± 3.10 |
| Jₐ₅₀ | 60.75^{b} ± 34.2 | 69.75^{b} ± 5.73 |
| Jₐ₇₅ | 161.75^{a} ± 24.5 | 68.00^{b} ± 23.6 |
| J_{b50} | 114.75^{ab} ± 52.1 | 85.75^{ab} ± 4.57 |
| J_{b75} | 74.5^{b} ± 32.5 | 80.25^{ab} ± 10.2 |
| SEM | 5.02 | 2.61 |

Mean values in the same column with different superscript differ significantly (P < 0.05). 1 U = 16.66 nKat/l; nKat = Amount of glandular kallikrein, which cleaves 0.005 mmol of substrate per minute

Alanine aminotransferase (ALT), also called serum glutamic pyruvate transaminase (SGPT), is an enzyme present in hepatocytes. When liver cells are damaged, it leaks into the blood. ALT rises dramatically in acute liver damage. In our study ALT activity in control was the highest, again indicating no toxicity in any of the plant protein fed groups.

5.6.1 Lysozyme Activity in Serum

Lysozyme activity in the serum of different experimental groups is shown in Table 10. Lysozyme plays an important role in non-specific immune responses, and it has been found in mucus, serum and ova of fish. Innate immunity due to lysozyme is caused by lysis of bacterial cell wall. This stimulates the phagocytosis of bacteria. The suppression of the non-specific immune capacity by high concentrations of dietary soybean proteins has been reported in rainbow trout (Burrells et al., 1999). In our study, there was no significant difference in lysozyme activity, but numerically it was higher in plant based fed diet (except Jₐ₇₅ group) groups, which shows that plant ingredients act as immunostimulating in fish.

5.6.2 Albumin, Globulin and Total Protein in the Blood

Albumin, globulin and total protein in the blood of the fish of different experimental groups are shown in Table 14. The concentration of total protein in blood was used as a basic index for health status of fish. Among the blood proteins, albumin and globulin are the major protein. Globulin is important for its immunological responses, especially its gamma component. Herein, total protein contents were almost similar in all the groups. Albumin content was lower in Jₐ₅₀ and Jₐ₇₅ groups but these values were similar to that in S75 group. Albumin contents in J_{b50} and J_{b75} were similar to that in control group. Globulin concentration in blood was higher in plant protein fed groups compared to animal protein fed groups. These results are consistent with the higher lysozyme activity observed in plant protein fed groups. Overall, albumin, globulin and total protein contents suggest no adverse effects in any of the groups.

TABLE 14
Lysozyme activity (IU/ml) in the serum, albumin (g/dl), globulin (g/dl) and total protein
(g/dl) in the blood of Cyprinus carpio fingerlings fed diets of the invention

| Treatment | Lysozyme activity | Albumin | Globulin | Total protein |
|---|---|---|---|---|
| Control | 336.4 ± 32.0 | 1.98^{a} ± 0.15 | 0.88^{c} ± 0.17 | 2.85^{ab} ± 0.13 |
| S₅₀ | 403.7 ± 101.9 | 1.63^{bc} ± 0.21 | 1.15^{bc} ± 0.13 | 2.80^{ab} ± 0.16 |
| S₇₅ | 457.5 ± 107.3 | 1.43^{bc} ± 0.28 | 1.18^{bc} ± 0.17 | 2.63^{b} ± 0.13 |
| Jₐ₅₀ | 328.5 ± 100.1 | 1.43^{bc} ± 0.10 | 1.45^{ab} ± 0.31 | 2.87^{ab} ± 0.34 |
| Jₐ₇₅ | 287.5 ± 107.2 | 1.35^{c} ± 0.19 | 1.75^{a} ± 0.30 | 3.10^{a} ± 0.20 |
| J_{b50} | 447.7 ± 172.9 | 1.73^{ab} ± 0.13 | 1.03^{c} ± 0.19 | 2.75^{b} ± 0.17 |
| J_{b75} | 401.8 ± 186.7 | 1.63^{bc} ± 0.35 | 1.20^{bc} ± 0.12 | 2.80^{ab} ± 0.24 |
| SEM | 23.75 | 0.05 | 0.06 | 0.04 |

IU - The amount of enzyme required to produce a change in the absorbance at 450 nm of 0.001 units per minute at pH 6.24 and 25° C., using a suspension of Micrococcus lysodeikticus as the substrate. Mean values in the same column with different superscript differ significantly (P < 0.05).

5.6.3 Glucose, Total Bilirubin (TBIL), Creatinine and Ions in Blood

Concentration of blood glucose, TBIL, creatinine and ions (calcium, phosphorus, sodium and potassium) are shown in Tables 15 and 16. Lower blood glucose level was in animal protein fed group, i.e. control group, whereas plant fed groups had higher blood glucose level. As content of plant material increased in diet, blood glucose level also increased. This could be ascribed to higher level of carbohydrates in plant based diet, which propel to form more glucose in the blood. There was no change in total bilirubin content in the blood. Creatinine level in the control was higher, but was similar for soybean meal and detoxified Jatropha meal fed groups. The ion levels were also within the normal ranges. These results also suggest no toxicity in any of the groups.

TABLE 15
Effects of experimental diets on glucose (mg/dl), total
bilirubin (mg/dl), blood urea nitrogen (mg/dl) and creatinine
(mg/dl) in blood of Cyprinus carpio fingerlings

| Treatment | Glucose | TBIL | Creatinine |
|---|---|---|---|
| Control | 72.75^{b} ± 4.03 | 0.3 ± 0.00 | 1.35^{a} ± 0.70 |
| S₅₀ | 91.25^{ab} ± 8.81 | 0.225 ± 0.05 | 0.40^{b} ± 0.14 |
| S₇₅ | 99.00^{a} ± 2.46 | 0.275 ± 0.05 | 0.25^{b} ± 0.06 |
| Jₐ₅₀ | 86.75^{ab} ± 8.62 | 0.25 ± 0.06 | 0.25^{b} ± 0.06 |
| Jₐ₇₅ | 97.50^{a} ± 2.82 | 0.25 ± 0.06 | 0.23^{b} ± 0.05 |
| J_{b50} | 87.75^{ab} ± 4.03 | 0.225 ± 0.05 | 0.33^{b} ± 0.15 |
| J_{b75} | 97.75^{a} ± 5.63 | 0.225 ± 0.05 | 0.20^{b} ± 0.00 |
| SEM | 2.95 | 0.01 | 0.09 |

TABLE 16
Effects of experimental diets on blood ions (calcium
(mg/dl), phosphorus mg/dl, sodium (mmol/l) and potassium
(mmol/l) of Cyprinus carpio fingerlings

| Treatment | Calcium | Phosphorus | Sodium | Potassium |
|---|---|---|---|---|
| Control | 10.43 ± 1.05 | 5.93 ± 0.98 | 131.25 ± 3.86 | 1.55^{ab} ± 0.10 |
| S₅₀ | 10.53 ± 0.64 | 7.93 ± 0.38 | 130.25 ± 3.30 | 1.50^{bc} ± 0.00 |
| S₇₅ | 10.35 ± 0.39 | 7.45 ± 0.87 | 133.50 ± 4.20 | 4.23^{cd} ± 0.51 |
| Jₐ₅₀ | 9.98 ± 0.59 | 7.63 ± 0.23 | 129.00 ± 1.63 | 2.18^{e} ± 0.50 |
| Jₐ₇₅ | 10.60 ± 1.14 | 5.10 ± 1.69 | 129.50 ± 1.91 | 2.80^{d} ± 0.76 |
| J_{b50} | 10.15 ± 0.39 | 7.78 ± 1.13 | 131.00 ± 2.45 | 4.40^{a} ± 0.57 |
| J_{b75} | 9.60 ± 0.42 | 6.30 ± 1.10 | 130.75 ± 2.06 | 2.85^{cd} ± 0.17 |
| SEM | 0.14 | 0.43 | 0.55 | 0.31 |

Mean values in the same column with different superscript differ significantly (P < 0.05).

5.6.4 Histopathological Findings

Liver, kidney and spleen sections of all the groups were normal. Pathological alterations characterized as ‘Catarrhal enteritis’ (necrosis of enterocytes, denudation of the lamina epithelial layers and influx of leucocytes into the lamina propria) were observed only in sections of gut tissues of Jₐ₅₀ and Jₐ₇₅ groups. Hyperemia and inflammation were also observed in the gut sections from these two groups. The degree of changes was higher in Jₐ₇₅ than in Jₐ₅₀, i.e. the higher the incorporation of step A detoxified kernel meal in the diet was, the higher the degree of adverse effects was. The gut was the first organ that went in contact with the toxin. The level of the toxin was not high enough to elicit adverse effects in other organs. In the intestine, necrosis of enterocytes on the tips and sides, contracting and shortening of the villus impacts digestion and absorption. It may be noted that the growth performance and nutrient utilization were also lowest in Jₐ₇₅ group. It may be recalled that snail mortality was observed by the extract obtained from step A detoxified kernel meal. These results suggest that feeding of step B detoxified kernel meal does not produce any adverse effects in organs, and it is safe for inclusion in fish diet.

5.7 Phorbol Esters in Muscle

Phorbol esters were measured in liver, intestine and muscle of fish fed detoxified Jatropha kernel meal (step B). These organs were free of phorbol esters, suggesting that the fish are safe for human consumption.

B) Method for Preparing a Phorbol-Ester Free Jatropha Protein Isolate

1. Detoxification Method

Jatropha seed cake (crude protein 23.6%, oil 9.3%, ash 5.8%; all on dry matter basis) was ground to pass through 1 mm sieve. The ground seed cake (100 g) was mixed in 1 litre of water, temperature brought to 60° C., and pH raised to 11. It was kept stirring for 1 h at 60° C., and every 15 min the pH was adjusted to 11, since it dropped slightly with time. A total of 25.5 ml of 6 M NaOH was required for adjusting pH to 11. The contents were centrifuged at 3000 g for 10 min to collect the supernatant. The supernatant was then filtered to remove suspended particles. Total amount of the recovered filtrate was 715 ml±5 (mean±SD, n=3).

The filtrate was brought to room temperature (23-25° C.), and the pH was reduced to pH 8 by slowly adding 1 M HCl. A total of 44.6 ml of 1 M HCl was required. At this pH, no protein was precipitated. The total volume after addition of HCl was 760 ml and it was designated as Solution P.

An aliquot (200 ml) of Solution P was taken and 800 ml of 95% ethanol added. The contents were kept mixing on a magnetic stirrer for 30 min, and then centrifuged at 3000 g for 10 min. The pellet was collected and washed by adding 150 ml of 80% ethanol, stirring for 5 min on a magnetic stirrer and centrifuging (3000 g for 10 min). The recovered pellet was again washed twice by the addition of 150 ml of 80% ethanol, followed by centrifugation (3000 g, 10 min) and lyophilized or dried at 40° C.

From 200 ml of Solution P, 4.83 g+0.08 (mean±SD, n=3) protein isolate were recovered. The recovery of protein isolate from 760 ml was 4.83×3.8 corresponding to 18.35 g. Thus, in summary, from 100 g seed cake (with 93.1% dry matter) 19.7% (=18.35/0.931) protein isolate was recovered.

In an independent study, the method was performed using denatured ethanol, because it is cheaper in Europe than the ethanol that does not contain denaturing agents. The denatured ethanol contained various commonly used denaturing agents (toluol, cyclohexane, petroleum ether, acetic acid or a mixture of isopropanol and tertiary butanol). It was used only for the precipitation step whereas the washing steps were done with ethanol free of denaturing agent. The recovery of the protein isolate was not statistically different from that mentioned above (19.7%) and it was free of phorbol esters. Since the protein isolate is meant for feeding to fish and livestock, ethanol containing acetic acid as a denaturing agent is preferred since acetic acid is safe for human (vinegar is diluted acetic acid and is edible) and animal consumption.

2 Characterization of the Protein Isolate (All Data on Dry Matter Basis)

Crude protein content: (N×6.25)=87.4%; Lipid=1.3%; Ash=2.7%; Gross energy=21.3 MJ/kg.

Phorbol esters: Not detected (not detected means phorbol ester levels of <3 ppm)

Amino acid levels: A comparison between the amino acid composition of the phorbol ester free protein isolate, soybean meal and the FAO reference protein for a growing child of 2 to 5 years of age revealed an almost similar pattern for all essential amino acids, except lysine and sulphur amino acids which were lower in the protein isolate (Table 17).

TABLE 17
Amino acid composition (g/16 g nitrogen) of the protein
isolate, soybean meal and the FAO reference protein

| | Jatropha detoxified | Soybean | FAO |
|---|---|---|---|
| Aminoacids | material | meal | (ref protein)^{a} |
| Essential | | | |
| Methionine | 1.76 | 1.32 | 2.50* |
| Cystine | 0.44 | 1.38 | |
| Valine | 7.02 | 4.50 | 3.50 |
| Isoleucine | 4.48 | 4.16 | 2.80 |
| Leucine | 7.62 | 7.58 | 6.60 |
| Phenylalanine | 5.05 | 5.16 | 6.30** |
| Tyrosine | 2.96 | 3.35 | |
| Histidine | 3.74 | 3.06 | 1.90 |
| Lysine | 2.91 | 6.18 | 5.80 |
| Arginine | 11.9 | 7.64 | |
| Threonine | 3.79 | 3.78 | 3.40 |
| Tryptophan | 1.16 | 1.36 | 1.10 |
| Non-essential | | | |
| Serine | 5.01 | 5.18 | — |
| Glutamic acid | 13.10 | 19.92 | — |
| Aspartic acid | 9.50 | 14.14 | — |
| Proline | 5.70 | 5.99 | — |
| Glycine | 4.75 | 4.52 | — |
| Alanine | 5.13 | 4.54 | — |

*Methionine plus cystine;
**Phenylalanine plus tyrosine
^{a}FAQ/WHO (1990) reference pattern suggested for pre-school children (2-5 years old).

This method isolates proteins and simultaneously removes phorbol esters in one step. While the protein isolate prepared from Jatropha seed cake using the principle of isoelectric pH had substantial amount of phorbol esters (1.48 mg/g), lower protein content (76%) and lower recovery (17%). Detoxification using methanol containing alkali showed a protein recovery of 14%. Thus this method of isolating proteins from Jatropha seed cake and making it free of phorbol esters in one step has several advantages, for example higher recovery of phorbol ester free protein isolate, higher protein content and absence of phorbol esters.

3 Feeding of Protein Isolate to Fish (Carp, Cyprinus carpio L.)

The protein isolate was heat treated. The moisture content of the isolate was brought to approximately 66% by adding water (200 g water was added to 100 g of the protein isolate). It was heated at 121° C. for 20 min, and then dried at 40° C. This material was free of lectins and trypsin inhibitor. Phytate content was 4.15%. The heated protein isolate (designated hence forth as DPI; detoxified protein isolate) was added in the fish diet (see below).

3.1 Diet Formulation, Experimental System and Animals

Prior to feed formulation, the proximate composition of detoxified Jatropha protein isolate (DPI), wheat meal, and fish meal (FM) was determined. Three isonitrogenous diets were formulated. Experimental diets contained crude protein 38%, crude lipid 9%, vitamin premix 2%, mineral premix 2% and titanium oxide (TiO₂) Lysine was supplemented in the diets that contained DPI. Each experimental feed, except the control, contained 500 FTU phytase (NATUPHOS 5000G, BASF, Ludwigshafen) per kg. The inclusion levels of the DPI were as follows: Control diet (Control) was prepared with FM and wheat meal, without DPI; and J₅₀ and J₇₅ diets in which 50% and 75% of FM protein respectively was replaced by DPI (Table 3). The final mixture of each diet was made into 2 mm diameter moist pellets and then freeze-dried.

TABLE 18
Composition of the experimental diets (g/kg feed)

| | Experimental diets | | |
|---|---|---|---|
| Ingredients | Control | J₅₀ | J₇₅ |
| Fish meal | 484 | 242 | 121 |
| Wheat meal | 436 | 435 | 435 |
| Jatropha detoxified protein isolate | — | 183 | 273 |
| Cellulose | — | 36 | 55 |
| Sunflower oil | 40 | 64 | 76 |
| Vitamin premix | 20 | 20 | 20 |
| Mineral premix | 20 | 20 | 20 |
| Total | 1000 | 1000 | 1000 |
| Lysine | — | 6.4 | 9.6 |
| Phytase (FTU/kg) | — | 500 | 500 |
| TiO₂ | 10 | 10 | 10 |

Control: Fish meal and wheat meal, without any Jatropha protein isolate, J₅₀: 50% of fish meal proteins replaced by Jatropha protein isolate, J₇₅: 75% of FM protein replaced by Jatropha protein isolates,
¹Whole wheat meal.
²Vitamin premix (g or IU kg⁻¹ premix): retinol palmitate, 500000 IU; thiamine, 5; riboflavin, 5; niacin, 25; folic acid, 1; pyridoxine, 5; cyanocobalamine, 5; ascorbic acid, 10; cholecalciferol; 50000 IU; α-tocopherol, 2.5; menadione, 2; inositol, 25; pantothenic acid, 10; choline chloride, 100; biotin, 0.25.
³Mineral premix (g kg−1): CaCO₃, 336; KH₂PO₄, 502; MgSO₄•7H₂O, 162; NaCl, 49.8; Fe(II) gluconate, 10.9; MnSO₄•H₂O, 3.12; ZnSO₄•7H₂O, 4.67; CuSO₄•5H₂O, 0.62; KI, 0.16; CoCl₂•6H₂O, 0.08; ammonium molybdate, 0.06; NaSeO₃, 0.02.

Common carp (Cyprinus carpio L.) fingerlings obtained from the Institute of Fisheries Ecology and Aquaculture of the Federal Research Center for Fisheries at Ahensburg, Germany were transferred to the University of Hohenheim, Stuttgart, Germany and kept in two 500 l capacity tanks for acclimatisation. After acclimatisation, 27 fish were randomly distributed into three groups with three replicates; each replicate contained three fish (av. wt. 20.2 g) in an aquarium (45 l capacity). All the aquaria were supplied with water from a recirculatory system. The system was subjected to a photoperiod of 12 h light:12 h darkness. Water quality was monitored throughout the experiment. Water flow was adjusted to keep the oxygen saturation above 80%. Before the start of the experiment, the fish were starved one day and then fed with 16 g feed per kg metabolic body mass (kg 0.8) per day (equal to five times their maintenance requirement) and split into 5 equal rations per day (at 8:00, 10:30, 13:00, 15:30 and 18:00 hours) during the experimental period. The food was dispensed using an automatic feeder. Fish were weighed individually at the beginning of the experiment and at weekly intervals during the experimental period to adjust the feeding level for the subsequent week. The fish were not fed on the weighing day. During the last two weeks of the experiment, the fish were fed with a diet containing a marker (TiO₂) and faeces were daily collected for digestibility measurements. In addition, six fish of the same population were killed and preserved at ·20° C. for analysis of the initial body composition at the start of the experiment,

The experiment was terminated after 12 weeks and the fish were sacrificed. At the end of experiment, two fish per group were anaesthetized by tricaine methanesulfonate (MS222; Sigma Chemical Co., USA) at 250 ppm in water. From one fish from each group blood was drawn near the caudal peduncle and transferred into a heparinized tube for hematological study. From a second fish from each group blood was drawn and divided into two equal parts of which one was used to obtain plasma, which was then stored at ·20° C. for determination of cholesterol and triglycerides. The other part was kept at room temperature for few minutes to collect serum, which was also stored at ·20° C. for lysozyme determination. One fish per group was carefully dissected to isolate muscle and stored at ·20° C. for determination of phorbol esters. One fish per group was sacrificed by hitting head with a metal rod and stored at ·20° C. for chemical composition analysis.

The University of Hohenheim Animal Welfare Committee approved all the experimental procedures involving in keeping, feeding and sacraficing of common carp.

3.2 Analysis of Phorbol Esters, Antinutrients and Amino Acid

The proximate composition of diets, of diet ingredients and of whole bodies of fish was determined using standard methods. Phorbol esters (PEs) were determined based on the method of Makkar et al. (1997). The results were expressed as equivalent to a standard, phorbol-12-myristate 13-acetate. Detection limit of PEs by HPLC was 3 μg/g protein isolates(=3ppm). Trypsin inhibitor activity was determined and the analysis of the lectin content was conducted by haemagglutination assay (Makkar et al., 1997). The Phytate content was determined using spectrometric methods and the amino acid compositions of FM, DPI and wheat meal were determined using an automated amino acid analyser after hydrolysing the samples with 6 M HCl at 110° C. for 24 h. The sulphur-containing amino acids were oxidised using performic acid before the acid hydrolysis and the tryptophan content of the above-mentioned samples was determined spectrophotometrically.

3.3 Growth and Nutrient Utilization Parameters

Growth performance and diet nutrient utilization were assessed in terms of body mass gain (BMG)=[(Final body mass−initial body mass)/Initial body mass]×100; specific growth rate (SGR)=[(In final body mass in g)−In initial body mass in g)/number of trial days]×100; metabolic growth rate (MGR)=(Body mass gain in g)/[{(initial body mass in g/1000)^{̂0.8}+(final body mass in g/1000)̂^{0.8}}/2]/number of trial days; feed gain ratio (FGR)=dry feed fed (g)/body mass gain (g); protein efficiency ratio (PER)=body mass gain (g)/crude protein fed (g); protein productive value (PPV)=[(final fish body protein in g−initial fish body protein in g)/total protein consumed in g]×100; lipid productive value (LPV)=[(final fish body lipid in g−initial fish body lipid in g)/total crude lipid consumed in g]×100 and energy productive value (EPV)=[(final fish body energy−initial fish body energy)/(gross energy intake)]×100.

3.4 Digestibility Measurement and Efficiency of Digestible Nutrients and Gross Energy

The apparent dry matter digestibility of diets was calculated as the apparent dry matter digestibility coefficient=[1−{(% TiO₂ in feed)/(% TiO₂ in faeces)}].

The nutrient and energy digestibility were obtained using the following formula:

Apparent nutrient digestibility coefficient=[1−{(% TiO₂ in feed)/(% TiO₂ in faeces)×(% Nutrient or energy in faeces)/(% Nutrient or energy in feed)}]

3.5 Haematological Parameters

Red blood cells (RBC) and white blood cells (WBC) were counted by using Neubauer's counting chamber of haemocytometer, under high power (40×) using an optical microscope. The Hb content of blood was analyzed by Reflotron Hemoglobin test (REF 10744964, Roche diagnostic GmbH, Manheim Germany). Hct was determined on the basis of sedimentation of blood. Heparinised blood (50·l) was taken in the hematocrit capillary (Na-heparinised) and centrifuged in the Hematocrit 210 Hettich Centrifuge (Tuttlingen Germany) to obtain hematocrit value. Lysozyme activity of serum was measured by EnzChek Lysozyme Assay Kit (E-22013, Leiden, The Netherlands). VetScan Chemistry Analyzer (Scil Animal care company GmbH, Germany) was used for determinations of alanine aminotransferase (ALT), albumin, alkaline phosphatase (ALP), total calcium (Ca⁺⁺), creatinine, globulin, phosphorus, potassium (K⁺), sodium (Na⁺), total bilirubin (TBIL), total protein, and urea nitrogen (BUN).

3.6 Statistical Analysis

All data were subjected to a one-way analysis of variance ANOVA and the significance of the differences between means was tested using Duncan's multiple range test (P<0.05). Values are expressed as means±standard deviation.

4 Chemical Composition, Antinutrient Contents and Amino Acid Composition of Feed Ingredients

Phorbol esters, Trypsin inhibitor and lectins were undetectable. Proximate composition and amino acid profiles of feed ingredients are shown in Table 19. Diets contained 38% crude protein 9.2-9.7%, crude lipid and 10.3-10.9% ash.

TABLE 19
Chemical composition, antinutrient contents and
amino acid composition of feed ingredients

| | | |
|---|---|---|
| | Detoxified | |
| Fish meal | protein isolate | Wheat meal |

Proximate composition (g/kg)

| | | | |
|---|---|---|---|
| Dry matter | 940 | 963 | 941 |
| Crude protein | 655 | 874 | 145 |
| Crude lipid | 88 | 13 | 16.3 |
| Crude ash | 142 | 27 | 14 |
| Gross energy (KJ/g) | 21.1 | 21.3 | 18.7 |

Antinutrients

| | | | |
|---|---|---|---|
| Trypsin inhibitor (mg trypsin | ND | ND | — |
| inhibited per g sample) | | | |
| Lectin^{a} | ND | ND | — |
| Phytate (% dry matter) | — | 4.1 | — |

Essential amino acids composition (g/kg)

| | | | |
|---|---|---|---|
| Arginine | 35.3 | 104.0 | 5.4 |
| Histidine | 17.7 | 32.7 | 3.4 |
| Iso leucine | 22.8 | 39.2 | 4.2 |
| Leucine | 41.6 | 64.1 | 9.1 |
| Lysine | 40.9 | 25.4 | 3.3 |
| Phenylalanine | 21.8 | 44.1 | 6.5 |
| Methionine | 16 | 15.4 | 2.0 |
| Threonine | 23 | 33.1 | 3.7 |
| Tryptophan | 4.9 | 10.2 | 1.4 |
| Valine | 29.3 | 61.3 | 5.1 |

Non-essential amino acids composition (g/kg)

| | | | |
|---|---|---|---|
| Alanine | 43.3 | 44.9 | 4.6 |
| Asparginine | 60.5 | 83.1 | 7.2 |
| Cystine | 4.3 | 3.8 | 2.9 |
| Serine | 25.5 | 43.8 | 6.3 |
| Glutamine | 79.4 | 114.8 | 44.9 |
| Glycine | 59.8 | 41.5 | 5.6 |
| Tyrosine | 14.8 | 25.9 | 3.3 |
| Proline | 36.9 | 49.8 | 14.5 |

ND: Not detected;
^{a}Minimum amount of material (mg/ml assay medium) that produced agglutination.

5 Fish Behaviour, Feed Intake and Growth

Based on the visual observation during feeding time, palatability or acceptability of all feeds was good and the behaviour of fish was normal. No left feed was observed in the aquaria. In earlier studies fish rejected feed containing even a small amount of phorbol esters. Good palatability in the present study indicated the absence of any toxic compounds in the DPI containing diets. Weekly body mass gains of fish are given in Table 20. These data showed differential growth among the respective groups and a lower body mass development was observed in J₇₅ and control groups than J₅₀ group from the third week onwards. This trend was maintained until the end of the experiment. Growth performance and nutrient utilization parameters are presented in Table 21. BMG, SGR, MGR, FGR and EPV did not differ significantly among the three groups. The highest PER was observed for the J₅₀ group. It was not significantly different from that of the control group but significantly higher (P<0.05) than that of the J₇₅ group. Significantly higher (p<0.05) PPV and LPV were observed for DPI fed groups than for the control group. These results demonstrated the excellent nutritional value of DPI and suggested the absence of any deleterious compound(s) in DPI. This study demonstrates that a high replacement level (up to 75%) of FM protein by a single plant-protein source such as DPI is possible in common carp, since overall growth performance and protein or energy utilisation of this group were similar to those of the FM fed group (control).

6 Nutrient Digestability

Highest ADCs of protein and energy were observed for the J₅₀ group and these were significantly higher (p<0.05) compared to those for other groups; whereas, ADCs of dry matter and lipid did not differ significantly among the three groups (Table 21). Apparent digestibility coefficients of oil seed meal proteins and plant protein isolates are 0.80-0.95 and 0.90-0.98 respectively for tilapia, trout, Atlantic salmon and common carp. The protein digestibility coefficient is a key factor in the evaluation of the quality of a diet and in particular in determining its potential for the synthesis of new tissues. Excellent dry matter, crude protein, lipid and energy digestibilities were observed in the present study on feeding DPI in combination with FM protein (Table 21), indicating excellent utilization of feed ingredients.

TABLE 20
Weekly body mass gain of common carp fingerlings
fed with the respectable experimental diets

| | Body mass (g) | | |
|---|---|---|---|
| Weeks | Control | J₅₀ | J₇₅ |
| Initial body mass | 20.2 ± 0.12 ^{a} | 20.3 ± 0.12 ^{a} | 20.2 ± 0.07 ^{a} |
| 1^{st} | 25.7 ± 0.27 ^{a} | 25.7 ± 0.19 ^{a} | 25.5 ± 0.38 ^{a} |
| 2^{nd} | 32.5 ± 0.71 ^{a} | 32.9 ± 0.27 ^{a} | 32.0 ± 0.96 ^{a} |
| 3^{rd} | 41.3 ± 0.91 ^{a} | 41.2 ± 0.25 ^{a} | 39.7 ± 1.55 ^{a} |
| 4^{th} | 48.9 ± 1.63 ^{a} | 48.7 ± 0.60 ^{a} | 47.2 ± 3.25 ^{a} |
| 5^{th} | 57.9 ± 2.23 ^{a} | 57.9 ± 2.36 ^{a} | 55.5 ± 4.11 ^{a} |
| 6^{th} | 66.3 ± 3.27 ^{a} | 66.1 ± 2.03 ^{a} | 63.5 ± 5.39 ^{a} |
| 7^{th} | 76.2 ± 4.14 ^{a} | 76.6 ± 2.41 ^{a} | 72.7 ± 6.98 ^{a} |
| 8^{th} | 85.4 ± 5.03 ^{a} | 86.2 ± 3.41 ^{a} | 80.4 ± 7.37 ^{a} |
| 9^{th} | 97.4 ± 6.40 ^{a} | 98.5 ± 7.17 ^{a} | 89.6 ± 9.77 ^{a} |
| 10^{th} | 106.5 ± 7.71 ^{a} | 107.8 ± 8.51 ^{a} | 98.3 ± 12.59 ^{a} |
| 11^{th} | 115.7 ± 8.62 ^{a} | 118.4 ± 7.97 ^{a} | 107.9 ± 15.00 ^{a} |
| 12^{th} | 124.3 ± 8.90 ^{a} | 127.5 ± 5.69 ^{a} | 117.7 ± 13.52 ^{a} |

Control: Fish meal and wheat meal, without any Jatropha protein isolate, J₅₀: 50% of fish meal proteins replaced by Jatropha protein isolate, J₇₅: 75% of FM protein replaced by Jatropha protein isolates, Values are mean (n = 3) ± standard deviation. Mean values in the same row with different superscript differ significantly (p < 0.05).

TABLE 21
Growth performance, nutrient utilization and digestibility of digestible nutrients

| Treatment | Control | J₅₀ | J₇₅ |
|---|---|---|---|
| Initial weight (g) | 20.2 ± 0.10 | 20.3 ± 0.09 | 20.2 ± 0.07 |
| Final weight (g) | 124.3 ± 8.90 | 127.5 ± 5.69 | 117.7 ± 13.52 |
| Body mass gain (%) | 515 ± 39 | 528 ± 25 | 483 ± 65 |
| Specific growth rate (%) | 2.16 ± 0.09 | 2.21 ± 0.06 | 2.10 ± 0.15 |
| Metabolic growth rate | 13.1 ± 0.49 | 13.6 ± 0.28 | 12.9 ± 0.80 |
| (g/kg^{0.8}/day) | | | |
| Feed gain (ratio) | 1.35 ± 0.05 | 1.30 ± 0.03 | 1.38 ± 0.10 |
| Protein efficiency (ratio) | 1.92 ± 0.09 ^{a b} | 2.00 ± 0.06 ^{a} | 1.87 ± 0.13 ^{b} |
| Protein productive (value) | 30.6 ± 2.81 ^{b} | 34.4 ± 1.29 ^{a} | 33.5 ^{a} ± 2.79 ^{a} |
| Lipid Productive (value) | 35.3 ± 7.80 ^{b} | 47.9 ± 8.13 ^{a} | 55.9 ± 10.45 ^{a} |
| Energy productive (value) | 22.2 ± 1.08 ^{a} | 24.0 ± 5.90 ^{a} | 23.9 ± 2.20 ^{a} |
| Dry matter digestibility | 0.821 ± 0.045 | 0.855 ± 0.024 | 0.829 ± 0.031 |
| (coefficient) | | | |
| Protein digestibility | 0.899 ^{b} ± 0.100 | 0.929 ^{a} ± 0.016 | 0.889 ^{b} ± 0.020 |
| (coefficient) | | | |
| Lipid digestibility | 0.939 ± 0.016 | 0.951 ± 0.017 | 0.941 ± 0.025 |
| (coefficient) | | | |
| Energy digestibility | 0.880 ^{b} ± 0.013 | 0.909 ^{a} ± 0.0161 | 0.888 ^{b} ± 0.021 |
| (coefficient) | | | |

Control: Fish meal and wheat meal, without any Jatropha protein isolate; J₅₀: 50% of fish meal proteins replaced by Jatropha protein isolate; J₇₅: 75% of FM protein replaced by Jatropha protein isolates; Values are mean (n = 3) ± standard deviation. Mean values in the same column with different superscript differ significantly (p < 0.05).

7 Chemical Composition of Whole Body of Fish

Whole body chemical composition of fish was analyzed and is shown in Table 22. It was significantly affected by dietary treatments. Moisture content exhibited inverse relationship with lipid and protein contents in common carp. A significantly higher crude lipid deposition was observed in DPI fed groups than in the control group. As DPI increased in the common carp diet, lipid deposition in the whole body also increased. The higher lipid content in fish of DPI fed groups led to a higher value of LPV compared to the control group (Table 21).

Crude protein content of whole bodies was higher in DPI fed groups than in the control group (Table 22), which concurs with the higher value of PPV in DPI fed groups (Table 21). Efficient protein synthesis requires sufficient availability of all essential amino acids. Unbalanced amino acid concentrations in a diet results in increased protein degradation, and thereby increased protein turnover. Interestingly in our investigation crude protein content in whole body was higher in DPI fed groups. These observations suggest that DPI containing diets contained optimum digestible energy, a balanced amino acid profile for optimum growth of common carp and were free of any compound that could be detrimental to the test animal. Phorbol esters were not detected in the muscle samples obtained from fish in J₅₀ and J₇₅ groups, suggesting its safe use by human consumption.

TABLE 22
Moisture, chemical composition and gross energy of whole
body of common carp fingerlings of different experimental
groups at the start and end of the experiment

| | | Crude protein | Crude lipid | |
|---|---|---|---|---|
| | Moisture | (g/kg) | (g/kg) | Gross energy |
| Treatment | (%) | wet basis | wet basis | (MJ/kg) |
| Initial fish | 77.9 ± 1.53 | 13.9 ± 0.09 | 4.2 ± 0.20 | 4.1 ± 0.09 |
| Control | 75.2 ± 1.08 ^{a} | 15.5 ± 0.70 ^{b} | 5.2 ± 1.09 ^{b} | 5.6 ± 0.20 ^{b} |
| J₅₀ | 73.1 ± 1.00 ^{b} | 16.3 ± 0.45 ^{a b} | 6.4 ± 1.50 ^{a b} | 6.0 ± 0.25 ^{a} |
| J₇₅ | 73.0 ± 0.50 ^{b} | 17.0 ± 0.29 ^{a} | 7.0 ± 1.00 ^{a} | 6.2 ± 0.40 ^{a} |

Control: Fish meal and wheat meal, without any Jatropha protein isolate, J₅₀: 50% of fish meal proteins replaced by Jatropha protein isolate, J₇₅: 75% of FM protein replaced by Jatropha protein isolates, Values are mean (n = 3) ± standard deviation. Mean values in the same column with different superscript differ significantly (P < 0.05).

8 Blood Chemistry

The WBC counts and Hb content did not differ significantly among the three groups. RBC count and Hct content were highest in J₇₅ group, followed by J₅₀ and the control group (Table 23). As the DPI content increased, an increase in the RBC count was observed. Plant ingredients may cause early release of immature erythrocytes, increasing the RBC count. The Hb and Hct assays are normally used as general indicators of fish health. Hemoglobin level in all groups was within the normal range and did not differ significantly among the three groups. In the present study higher Hct content was observed in DPI fed groups, which was attributed to the added phytase, which would have mitigated any possible adverse effects of phytate.

The concentration of total protein in blood is used as a basic index for health and nutrititional status in fish. Albumin is used as an indicator of liver impairment. Albumin and total blood protein did not differ significantly among the three groups (Table 23), indicating that there are no nutritional deficiencies and no impaired protein metabolism in the liver. Among the blood protein, globulin is the major protein, which plays a significant role in the immune response. Globulin concentration in the blood of fish with DPI based diets, was significantly higher than that in the control group, suggesting an immunostimulating effect of DPI in common carp. Lysozyme has an important role in nonspecific immune response and it is found in mucus, serum and ova of fish. Innate immunity due to lysozyme is caused by lysis of bacterial cell wall and this stimulates the phagocytosis of bacteria. The suppression of the non-specific immune capacity by high concentrations of dietary soybean proteins has been reported in rainbow trout previously (Burrells et al., 1999). In the present study, lysozyme activity was not significantly different amongst the respective groups (Table 23), but it was numerically higher in DPI fed groups, indicating immunostimulating effect of DPI in common carp.

9 Metabolic Enzymes and Blood Ions

Alkaline phosphatase and ALT are released into blood during organ damage. Alanine transaminase, also called serum glutamic pyruvate transaminase, is an enzyme present in hepatocytes (liver cells) and released into the blood if liver cells are damaged. Thus, detection of blood levels of ALP and ALT provides information on the damage of organs and in particular of liver cells. Activities of ALP and ALT were similar in all fish groups (Table 24), indicating normal organ function on feeding of DPI.

Blood urea nitrogen concentrations were in the normal ranges. Blood urea nitrogen concentrations are thought to be associated with liver or gill dysfunction, as these are the sites of urea production and excretion, respectively. Blood urea nitrogen concentration did not differ significantly among the three groups (Table 24), suggesting that DPI fed groups was normal and healthy. Total bilirubin, an indicator of liver dysfunction was similar for all groups. Creatinine, a degradation product of creatine, is involved in muscle energy metabolism and is used as an indicator of kidney damage or malfunction. It is normally quite stable in blood and its levels become elevated if kidney function is impaired. Creatinine was highest in the control group however within the normal range, probably due to the highest content of FM in this group. Potassium and sodium ions in blood did not differ significantly among the three groups. Detoxified Jatropha protein isolate based diets were supplemented with phytase which leads to an increased release of phosphorus and calcium ions from the feed and makes them available for common carp. This lead to higher blood ions (phosphorus and calcium) in DPI fed groups (Table 24). The histopathological findings based on liver, kidney, spleen and intestine sections did not show any adverse effects.

TABLE 23
Effects of experimental diets on the haematological parameters

| Treatment | Control | J₅₀ | J₇₅ |
|---|---|---|---|
| RBC (10⁶ cells/ | 1.25 ^{c} ± 0.05 | 1.38 ^{b} ± 0.02 | 1.43 ^{a} ± 0.02 |
| mm³) | | | |
| WBC (10³ cells/ | 0.78 ± 0.04 | 0.79 ± 0.06 | 0.77 ± 0.06 |
| mm³) | | | |
| Hb (g/dl) | 5.0 ± 0.00 | 5.2 ± 0.50 | 5.0 ± 0.00 |
| Hct (%) | 32 ^{b} ± 5.10 | 40 ^{a b} ± 12.31 | 45 ^{a} ± 4.57 |
| Albumin (g/dl) | 1.97 ± 0.38 | 2.17 ± 0.16 | 1.77 ± 0.35 |
| Globulin (g/dl) | 0.93 ^{c} ± 0.06 | 0.97 ^{b} ± 0.12 | 1.07 ^{a} ± 0.15 |
| Total protein (g/dl) | 2.90 ± 0.44 | 3.13 ± 0.15 | 2.83 ± 0.12 |
| Lysozyme activity | 386 ± 52 | 448 ± 61 | 402 ± 92 |
| (IU/ml) | | | |

Control: Fish meal and wheat meal, without any Jatropha protein isolate, J₅₀: 50% of fish meal proteins replaced by Jatropha protein isolate, J₇₅: 75% of FM protein replaced by Jatropha protein isolates Values are mean (n = 3) ± standard deviation. Mean values in the same column with different superscript differ significantly (P < 0.05). IU- The amount of enzyme required producing a change in the absorbance at 450 nm of 0.001 units per minute at pH 6.24 and 25° C., using a suspension of Micrococcus lysodeikticus as the substrate.
red blood cells, RBC; white blood cells, WBC; hemoglobin, Hb; haemacrotic, Hct; albumin, globulin and total protein in blood and lysozyme activity in the serum of common carp fingerlings

TABLE 24
Effects of experimental diets on alkaline phosphatase (ALP), alanine
transaminase (ALT), total bilirubin (TBIL), blood urea nitrogen
(BUN) and creatinine in blood, and blood ions (calcium, phosphorus,
sodium and potassium) levels in common carp fingerlings

| Treatment | Cₒₙₜᵣₒₗ | J₅₀ | J_{62.5} |
|---|---|---|---|
| ALP (U/l) | 144 ± 6.8 | 159 ± 12.9 | 179 ± 61.3 |
| ALT (U/l) | 88 ± 3.9 | 74 ± 16.7 | 87 ± 9.2 |
| TBIL (mg/dl) | 0.27 ± 0.06 | 0.23 ± 0.06 | 0.30 ± 0.00 |
| BUN (mg/dl) | 2.87 ± 0.81 | 3.37 ± 0.58 | 3.17 ± 0.68 |
| Creatinine (mg/dl) | 1.96 ± 1.57 ^{a} | 0.71 ± 0.10 ^{b} | 0.61 ± 0.09 ^{b} |
| Calcium (mg/dl) | 10.3 ± 0.36 ^{c} | 10.7 ± 0.36 ^{b} | 11.7 ± 0.68 ^{a} |
| Phosphorus (mg/dl) | 12.8 ± 2.70 ^{a} | 14.6 ± 1.57 ^{b} | 15.1 ± 1.47 ^{b} |
| Sodium (mmol) | 129 ± 1.78 | 131 ± 1.65 | 130 ± 1.45 |
| Potassium (mmol) | 1.49 ± 0.08 | 1.51 ± 0.09 | 1.60 ± 0.11 |

Control: Fish meal and wheat meal, without any Jatropha protein isolate, J50: 50% of fish meal proteins replaced by Jatropha protein isolate, J75: 75% of FM protein replaced by Jatropha protein isolates Values are mean (n = 3) ± standard deviation. Values are mean (n = 3) ± standard deviation. Mean values in the same column with different superscript differ significantly (P < 0.05). 1 U = 16.66 nKat/l; nKat = Amount of glandular kallikrein which cleaves 0.005 mmol of substrate per minute).

The results of the current study demonstrated that the groups fed with detoxified Jatropha curcas protein isolate exhibited good growth performance (i. e. almost six times increase in fish body mass after 12 weeks). The detoxified protein isolate could replace 75% of fish meal protein without sacrificing fish yield. The biochemical and hematological parameters were within the normal ranges and similar to those in the control group (fish meal fed group), confirming that the protein isolate, evaluated in this study, is free of compound(s) that cause adverse effects. Thus, the detoxified Jatropha protein isolate has potential use in diets of aquaculture and other livestock species.

### REFERENCES

Adams, S. M., Greeley, M. S., Mchughlaw, J., Edward, J., Noga, E. J. and Zelikoff, J. T. (2003). Estuaries. 26(5): 1365-1382.

Aregheore, E. M., Becker, K. and Makkar, H. P. S. (2003). S. Pac. J. Nat. Sci. 21: 50-56.

Becker, K. and Makkar, H. P. S. (1998). Vet. Human Toxicol. 40: 82-86.

Burrells, C., Williams, P. D., Southgate, P. J. and Crampton, V. O. (1999). Vet. Immunol. Immunopathol. 72: 277-288.

Dembele, K., Haubruge, E. and Gaspar, C. (2000). Ecotoxicology and Environmental Safety 45: 49-54.

Dongmeza, E., Siddhuraju P., Francis G. and Becker K. (2006). Aquaculture. 261: 407-422.

Feitosa dos Santos, A. and Goulart Sant'Ana, A. E. (1999). 13: 660-664.

Goel, G., Makkar, H. P., Francis, G., Becker, K. (2007). Int. J. Toxicol. 26(4): 279-288.

Gross, H., Foidl, G., Foidl, N., (1997). Jatropha Conference, 4.4, 179-182

Liu, S. Y., Sporer, F., Wink, M., Jourdane, J., Henning, R., Li, Y. L. and Ruppel, A. (1997). Tropical Medicine and International Health, 2(2): 179-188.

Makkar, H. P. S. and Becker, K. (1997). In: Biofuels and industrial products from Jatropha curcas (Guebitz, G. M., Mittelbach, M., Trabi, M., eds.). 190-205, Dbv-Verlag für die Technische Universität Graz, Austria.

Makkar, H. P. S., Becker, K., Sporer, F. and Wink, M. (1997). J Agric. Food Chem. 45: 3152-3157.

Martinez-Herrera, J., Siddhuraju, P., Francis, G., Davila-Ortiz, G. and Becker, K. (2006). Food Chem. 96 (1): 0-89.

Saunders, R. M., Connor, M. A., Booth, A. N., Bickoff, E. M. and Kohler, G. O. (1972). Journal of Nutrition, 103: 530-535.

1. A method for detoxifying plant constituents from Jatropha comprising the steps of:
a) providing a warm aqueous mixture of at least one plant constituent of Jatropha;
b) adding an alkali to the mixture to obtain a pH value of approximately 11;
c) separating the mixture to obtain a supernatant;
d) adding an acid to the supernatant at room temperature to obtain a pH value of approximately 8;
e) adding a short-chain alcohol to the supernatant to obtain a precipitate;
f) separating the precipitate from the supernatant, and
g) washing the precipitate with a short-chain alcohol,
wherein a phorbol ester concentration of the residue is below the detection limit of high performance liquid chromatography.

2. The method of claim 1, wherein the short-chain alcohol added in step e) is added in a ratio of short-chain alcohol:supernatant of 3:1 to 5:1, preferably approximately 4:1.

3. The method of claim 1, wherein the short-chain alcohol added in step e) is about 70 vol.-% to 99 vol.-%, preferably about 80 vol.-% to 95 vol.-%, most preferred approximately 95 vol.-%.

4. The method of claim 1, wherein the short-chain alcohol added in step g) is about 70 vol.-% to 85 vol.-%, most preferred approximately 80 vol.-%.

5. The method of claim 1, wherein the short-chain alcohol is ethanol or methanol, preferably ethanol.

6. A method for detoxifying plant constituents from Jatropha comprising in the following order the steps of:
a) providing at least one plant constituent of Jatropha;
b) adding a solvent comprising simultaneously methanol and sodium hydroxide to the constituent to obtain a mixture;
c) heating the mixture; and
d) separating the mixture to yield a residue;
wherein a phorbol ester concentration of the residue is below the detection limit of high performance liquid chromatography and wherein the solvent comprises methanol at a concentration of about 70% to about 95% and sodium hydroxide at a concentration of about 0.01 M to about 0.3 M.

7. The method of claim 6 further comprising in the following order the steps of:
e) adding methanol to the residue to obtain a blend;
f) heating the blend; and
g) separating the blend to obtain a second residue.

8. The method of claim 7, wherein the phorbol ester concentration of the second residue is about 0.001 mg/g or less.

9. The method of claim 1, wherein Jatropha is Jatropha curcas, preferably a toxic genotype of Jatropha curcas, or a cross of different Jatropha species, preferably of toxic genotypes of Jatropha curcas.

10. The method of claim 6, wherein a quantitative proportion of the plant constituent to the solvent is about 1:10 (w/v) in the mixture.

11. The method of claim 7, wherein the quantitative proportion of the plant constituent to methanol is about 1:10 (w/v) in the blend.

12. The method of claim 6, wherein heating is performed at a temperature of about 50° C. to about 70° C., preferably about 60° C. to about 70° C.

13. The method of claim 6 further comprising the step of washing the residue with methanol.

14. The method of claim 1 further comprising the step of autoclaving the residue, preferably at a moisture of about 75%.

15. A detoxified material of Jatropha obtainable by the method of the preceding claims for producing a nourishment, wherein Jatropha is a toxic or low toxic genotype of Jatropha and the concentration of phorbol esters in the detoxified material is 3ppm or less.

16. Use of the detoxified material of claim 15 for producing a nourishment, preferably a feed for farm animals and aquaculture species.
